(19) United States
(12) Patent Application Publication
(10) Pub. No.: US 2023/0179941 A1
(43) Pub. Date: Jun. 8, 2023

(54) Audio Signal Rendering Method and Apparatus

(71) Applicant: Huawei Technologies Co., Ltd., Shenzhen (CN)

(72) Inventors: Bin Wang, Shenzhen (CN); Gavin Kearney, York (GB); Cal Armstrong, York (GB); Jiance Ding, Beijing (CN); Zhe Wang, Beijing (CN)

(21) Appl. No.: 18/161,527

(22) Filed: Jan. 30, 2023

Related U.S. Application Data
(63) Continuation of application No. PCT/CN2021/106512, filed on Jul. 15, 2021.

(30) Foreign Application Priority Data
Jul. 31, 2020 (CN) 202010763577.3

(51) Int. Cl. H04S 7/00; G10L 19/008

(52) U.S. Cl. CPC H04S 7/303; G10L 19/008; H04S 7/305; H04S 2420/01

(57) ABSTRACT

An audio signal rendering method includes obtaining a to-be-rendered audio signal by decoding a received bitstream, obtaining control information, where the control information indicates at least one of content description metadata, rendering format flag information, loudspeaker configuration information, application scene information, tracking information, posture information, or location information, and rendering the to-be-rendered audio signal based on the control information to obtain a rendered audio signal.

### CROSS-REFERENCE TO RELATED APPLICATIONS

This is a continuation of International Patent Application No. PCT/CN2021/106512 filed on Jul. 15, 2021, which claims priority to Chinese Patent Application No. 202010763577.3 filed on Jul. 31, 2020. The disclosures of the aforementioned applications are hereby incorporated by reference in their entireties.

### TECHNICAL FIELD

This application relates to audio processing technologies, and in particular, to an audio signal rendering method and apparatus.

### BACKGROUND

With continuous development of multimedia technologies, audio has been widely used in the fields such as multimedia communication, consumer electronics, virtual reality, and human-computer interaction. Users have increasingly high requirements on audio quality. Three-dimensional (3D) audio has a sense of space close to reality, can provide good immersive experience for a user, and has become a new trend of the multimedia technologies.

Virtual reality (VR) is used as an example. An immersive VR system requires not only astonishing visual effect but also realistic auditory effect. Audio-visual convergence can greatly improve experience of virtual reality. A core of virtual reality audio is a three-dimensional audio technology. A sound-channel-based signal format, an object-based signal format, and a scene-based signal format are three common formats in the three-dimensional audio technology. Audio signals that are obtained through decoding and that are based on a sound channel, an object, and a scene are rendered, the audio signals can be replayed, thereby achieving fidelity and immersive auditory experience.

How to improve rendering effect of an audio signal becomes a technical problem that urgently needs to be resolved.

### SUMMARY

This application provides an audio signal rendering method and apparatus, to improve rendering effect of an audio signal.

According to a first aspect, an embodiment of this application provides an audio signal rendering method. The method may include obtaining a to-be-rendered audio signal by decoding a received bitstream; obtaining control information, where the control information indicates one or more of content description metadata, rendering format flag information, loudspeaker configuration information, application scene information, tracking information, posture information, or location information; and rendering the to-be-rendered audio signal based on the control information to obtain a rendered audio signal.

The content description metadata indicates a signal format of the to-be-rendered audio signal. The signal format includes at least one of a sound-channel-based signal format, a scene-based signal format, or an object-based signal format. The rendering format flag information indicates an audio signal rendering format. The audio signal rendering format includes loudspeaker rendering or binaural rendering. The loudspeaker configuration information indicates a layout of a loudspeaker. The application scene information indicates renderer scene description information. The tracking information indicates whether the rendered audio signal changes with head rotation of a listener. The posture information indicates an orientation and an amplitude of the head rotation. The location information indicates an orientation and an amplitude of body translation of the listener.

In this implementation, audio rendering effect can be improved by adaptively selecting a rendering manner based on at least one piece of input information of the content description metadata, the rendering format flag information, the loudspeaker configuration information, the application scene information, the tracking information, the posture information, or the location information.

In a possible design, rendering the to-be-rendered audio signal based on the control information includes at least one of performing rendering pre-processing on the to-be-rendered audio signal based on the control information; performing signal format conversion on the to-be-rendered audio signal based on the control information; performing local reverberation processing on the to-be-rendered audio signal based on the control information; performing grouped source transformation on the to-be-rendered audio signal based on the control information; performing dynamic range compression on the to-be-rendered audio signal based on the control information; performing binaural rendering on the to-be-rendered audio signal based on the control information; or performing loudspeaker rendering on the to-be-rendered audio signal based on the control information.

In this implementation, at least one of rendering pre-processing, signal format conversion, local reverberation processing, grouped source transformation, dynamic range compression, binaural rendering, or loudspeaker rendering is performed on the to-be-rendered audio signal based on the control information such that a proper rendering manner can be adaptively selected based on a current application scene or content in an application scene, to improve audio rendering effect.

In a possible design, the to-be-rendered audio signal includes at least one of a sound-channel-based audio signal, an object-based audio signal, or a scene-based audio signal. When the rendering the to-be-rendered audio signal based on the control information includes performing rendering pre-processing on the to-be-rendered audio signal based on the control information, the method may further include obtaining first reverberation information by decoding the bitstream, where the first reverberation information includes at least one of first reverberation output loudness information, information about a time difference between a first direct sound and an early reflected sound, first reverberation duration information, first room shape and size information, or first sound scattering degree information. Correspondingly, the performing rendering pre-processing on the to-be-rendered audio signal based on the control information to obtain the rendered audio signal may include performing control processing on the to-be-rendered audio signal based on the control information to obtain an audio signal obtained through the control processing, where the control processing includes at least one of performing initial 3 degree of freedom (DoF) processing on the sound-channel-based audio signal, performing conversion processing on the object-based audio signal, or performing initial 3DoF processing on the scene-based audio signal; performing, based on the first reverberation information, reverberation processing on the audio signal obtained through the control processing, to obtain a first audio signal; and performing binaural rendering or loudspeaker rendering on the first audio signal to obtain the rendered audio signal.

In a possible design, when the rendering the to-be-rendered audio signal based on the control information further includes performing signal format conversion on the to-be-rendered audio signal based on the control information, the performing binaural rendering or loudspeaker rendering on the first audio signal to obtain the rendered audio signal may include performing signal format conversion on the first audio signal based on the control information, to obtain a second audio signal; and performing binaural rendering or loudspeaker rendering on the second audio signal to obtain the rendered audio signal.

The signal format conversion includes at least one of converting a sound-channel-based audio signal in the first audio signal into a scene-based or object-based audio signal; converting a scene-based audio signal in the first audio signal into a sound-channel-based or object-based audio signal; or converting an object-based audio signal in the first audio signal into a sound-channel-based or scene-based audio signal.

In this implementation, signal format conversion is performed on the to-be-rendered audio signal based on the control information such that flexible signal format conversion can be implemented. Therefore, the audio signal rendering method in this embodiment of this application is applicable to any signal format, and audio rendering effect can be improved by rendering an audio signal in a proper signal format.

In a possible design, performing the signal format conversion on the first audio signal based on the control information may include performing signal format conversion on the first audio signal based on the control information, a signal format of the first audio signal, and processing performance of a terminal device.

In this implementation, signal format conversion is performed on the first audio signal based on the processing performance of the terminal device, to provide a signal format that matches the processing performance of the terminal device, perform rendering, and optimize audio rendering effect.

In a possible design, when the rendering the to-be-rendered audio signal based on the control information may further include performing local reverberation processing on the to-be-rendered audio signal based on the control information, performing binaural rendering or loudspeaker rendering on the second audio signal to obtain the rendered audio signal may include obtaining second reverberation information, where the second reverberation information is reverberation information of a scene of the rendered audio signal, and the second reverberation information includes at least one of second reverberation output loudness information, information about a time difference between a second direct sound and the early reflected sound, second reverberation duration information, second room shape and size information, or second sound scattering degree information; performing local reverberation processing on the second audio signal based on the control information and the second reverberation information to obtain a third audio signal; and performing binaural rendering or loudspeaker rendering on the third audio signal to obtain the rendered audio signal.

In this implementation, the corresponding second reverberation information may be generated based on the application scene information that is input in real time, and is used for rendering processing such that audio rendering effect can be improved, and real-time reverberation that matches the scene can be provided for an AR application scene.

In a possible design, performing the local reverberation processing on the second audio signal based on the control information and the second reverberation information to obtain a third audio signal may include separately performing clustering processing on audio signals in different signal formats in the second audio signal based on the control information, to obtain at least one of a sound-channel-based group signal, a scene-based group signal, or an object-based group signal; and separately performing, based on the second reverberation information, local reverberation processing on at least one of the sound-channel-based group signal, the scene-based group signal, or the object-based group signal, to obtain the third audio signal.

In a possible design, when rendering the to-be-rendered audio signal based on the control information may further include performing grouped source transformation on the to-be-rendered audio signal based on the control information, performing binaural rendering or loudspeaker rendering on the third audio signal to obtain the rendered audio signal may include performing real-time 3DoF processing, 3DoF+ processing, or 6DoF processing on a group signal in each signal format of the third audio signal based on the control information, to obtain a fourth audio signal; and performing binaural rendering or loudspeaker rendering on the fourth audio signal to obtain the rendered audio signal.

In this implementation, audio signals in all formats are processed in a unified manner such that processing complexity can be reduced while processing performance is ensured.

In a possible design, when rendering the to-be-rendered audio signal based on the control information further includes performing dynamic range compression on the to-be-rendered audio signal based on the control information, the performing binaural rendering or loudspeaker rendering on the fourth audio signal to obtain the rendered audio signal may include performing dynamic range compression on the fourth audio signal based on the control information, to obtain a fifth audio signal; and performing binaural rendering or loudspeaker rendering on the fifth audio signal to obtain the rendered audio signal.

In this implementation, dynamic range compression is performed on the audio signal based on the control information, to improve playing quality of the rendered audio signal.

In a possible design, rendering the to-be-rendered audio signal based on the control information to obtain a rendered audio signal may include performing signal format conversion on the to-be-rendered audio signal based on the control information, to obtain a sixth audio signal; and performing binaural rendering or loudspeaker rendering on the sixth audio signal to obtain the rendered audio signal.

The signal format conversion includes at least one of converting a sound-channel-based audio signal in the to-be-rendered audio signal into a scene-based or object-based audio signal; converting a scene-based audio signal in the to-be-rendered audio signal into a sound-channel-based or object-based audio signal; or converting an object-based audio signal in the to-be-rendered audio signal into a sound-channel-based or scene-based audio signal.

In a possible design, performing the signal format conversion on the to-be-rendered audio signal based on the control information may include performing signal format conversion on the to-be-rendered audio signal based on the control information, the signal format of the to-be-rendered audio signal, and processing performance of a terminal device.

The terminal device may be a device that performs the audio signal rendering method according to the first aspect of embodiments of this application. In this implementation, signal format conversion may be performed on the to-be-rendered audio signal with reference to the processing performance of the terminal device such that audio signal rendering is applicable to terminal devices with different performance.

For example, signal format conversion may be performed in two dimensions: algorithm complexity and rendering effect of the audio signal rendering method with reference to the processing performance of the terminal device. For example, if the processing performance of the terminal device is good, the to-be-rendered audio signal may be converted into a signal format with good rendering effect, even if algorithm complexity corresponding to the signal format with the good rendering effect is high. When the processing performance of the terminal device is poor, the to-be-rendered audio signal may be converted into a signal format with low algorithm complexity, to ensure rendering output efficiency. The processing performance of the terminal device may be processor performance of the terminal device. For example, when a dominant frequency of a processor of the terminal device is greater than a specific threshold, and a quantity of bits is greater than a specific threshold, the processing performance of the terminal device is good. A specific implementation of performing signal format conversion with reference to the processing performance of the terminal device may be another manner. For example, a processing performance parameter value of the terminal device is obtained based on a preset correspondence and a model of the processor of the terminal device. When the processing performance parameter value is greater than a specific threshold, the to-be-rendered audio signal is converted into a signal format with good rendering effect. Examples are not enumerated in embodiments of this application. The signal format with good rendering effect may be determined based on the control information.

In a possible design, rendering the to-be-rendered audio signal based on the control information to obtain a rendered audio signal may include obtaining second reverberation information, where the second reverberation information is reverberation information of a scene of the rendered audio signal, and the second reverberation information includes at least one of second reverberation output loudness information, information about a time difference between a second direct sound and an early reflected sound, second reverberation duration information, second room shape and size information, or second sound scattering degree information; performing local reverberation processing on the to-be-rendered audio signal based on the control information and the second reverberation information to obtain a seventh audio signal; and performing binaural rendering or loudspeaker rendering on the seventh audio signal to obtain the rendered audio signal.

In a possible design, rendering the to-be-rendered audio signal based on the control information to obtain a rendered audio signal may include performing real-time 3DoF processing, 3DoF+ processing, or 6DoF processing on an audio signal in each signal format of the to-be-rendered audio signal based on the control information to obtain an eighth audio signal; and performing binaural rendering or loudspeaker rendering on the eighth audio signal to obtain the rendered audio signal.

In a possible design, rendering the to-be-rendered audio signal based on the control information to obtain a rendered audio signal may include performing dynamic range compression on the to-be-rendered audio signal based on the control information to obtain a ninth audio signal;

and performing binaural rendering or loudspeaker rendering on the ninth audio signal to obtain the rendered audio signal.

According to a second aspect, an embodiment of this application provides an audio signal rendering apparatus. The audio signal rendering apparatus may be an audio renderer, a chip of an audio decoding device, or a system on chip, or may be a functional module that is in the audio render and that is configured to implement the method according to any one of the first aspect or the possible designs of the first aspect. The audio signal rendering apparatus may implement functions performed in the first aspect or the possible designs of the first aspect, and the functions may be implemented by hardware executing corresponding software. The hardware or the software includes one or more modules corresponding to the foregoing functions. For example, in a possible design, the audio signal rendering apparatus may include an obtaining module configured to obtain a to-be-rendered audio signal by decoding a received bitstream, a control information generation module configured to obtain control information, where the control information indicates one or more of content description metadata, rendering format flag information, loudspeaker configuration information, application scene information, tracking information, posture information, or location information; and a rendering module configured to render the to-be-rendered audio signal based on the control information to obtain a rendered audio signal.

The content description metadata indicates a signal format of the to-be-rendered audio signal. The signal format includes at least one of a sound-channel-based signal format, a scene-based signal format, or an object-based signal format. The rendering format flag information indicates an audio signal rendering format. The audio signal rendering format includes loudspeaker rendering or binaural rendering. The loudspeaker configuration information indicates a layout of a loudspeaker. The application scene information indicates renderer scene description information. The tracking information indicates whether the rendered audio signal changes with head rotation of a listener. The posture information indicates an orientation and an amplitude of the head rotation. The location information indicates an orientation and an amplitude of body translation of the listener.

In a possible design, the rendering module is configured to perform at least one of performing rendering pre-processing on the to-be-rendered audio signal based on the control information; performing signal format conversion on the to-be-rendered audio signal based on the control information; performing local reverberation processing on the to-be-rendered audio signal based on the control information; performing grouped source transformation on the to-be-rendered audio signal based on the control information; performing dynamic range compression on the to-be-rendered audio signal based on the control information; performing binaural rendering on the to-be-rendered audio signal based on the control information; or performing loudspeaker rendering on the to-be-rendered audio signal based on the control information.

In a possible design, the to-be-rendered audio signal includes at least one of a sound-channel-based audio signal, an object-based audio signal, or a scene-based audio signal. The obtaining module is further configured to obtain first reverberation information by decoding the bitstream, where the first reverberation information includes at least one of first reverberation output loudness information, information about a time difference between a first direct sound and an early reflected sound, first reverberation duration information, first room shape and size information, or first sound scattering degree information. Correspondingly, the rendering module is configured to perform control processing on the to-be-rendered audio signal based on the control information to obtain an audio signal obtained through the control processing, where the control processing includes at least one of performing initial 3DoF processing on the sound-channel-based audio signal, performing conversion processing on the object-based audio signal, or performing initial 3DoF processing on the scene-based audio signal; perform, based on the first reverberation information, reverberation processing on the audio signal obtained through the control processing, to obtain a first audio signal; and perform binaural rendering or loudspeaker rendering on the first audio signal to obtain the rendered audio signal.

In a possible design, the rendering module is configured to perform signal format conversion on the first audio signal based on the control information, to obtain a second audio signal; and perform binaural rendering or loudspeaker rendering on the second audio signal to obtain the rendered audio signal.

The signal format conversion includes at least one of converting a sound-channel-based audio signal in the first audio signal into a scene-based or object-based audio signal; converting a scene-based audio signal in the first audio signal into a sound-channel-based or object-based audio signal; or converting an object-based audio signal in the first audio signal into a sound-channel-based or scene-based audio signal.

In a possible design, the rendering module is configured to perform signal format conversion on the first audio signal based on the control information, a signal format of the first audio signal, and processing performance of a terminal device.

In a possible design, the rendering module is configured to obtain second reverberation information, where the second reverberation information is reverberation information of a scene of the rendered audio signal, and the second reverberation information includes at least one of second reverberation output loudness information, information about a time difference between a second direct sound and an early reflected sound, second reverberation duration information, second room shape and size information, or second sound scattering degree information; perform local reverberation processing on the second audio signal based on the control information and the second reverberation information to obtain a third audio signal; and perform binaural rendering or loudspeaker rendering on the third audio signal to obtain the rendered audio signal.

In a possible design, the rendering module is configured to separately perform clustering processing on audio signals in different signal formats in the second audio signal based on the control information, to obtain at least one of a sound-channel-based group signal, a scene-based group signal, or an object-based group signal; and separately perform, based on the second reverberation information, local reverberation processing on at least one of the sound-channel-based group signal, the scene-based group signal, or the object-based group signal, to obtain the third audio signal.

In a possible design, the rendering module is configured to perform real-time 3DoF processing, 3DoF+ processing, or 6DoF processing on a group signal in each signal format of the third audio signal based on the control information, to obtain a fourth audio signal; and perform binaural rendering or loudspeaker rendering on the fourth audio signal to obtain the rendered audio signal.

In a possible design, the rendering module is configured to perform dynamic range compression on the fourth audio signal based on the control information, to obtain a fifth audio signal; and perform binaural rendering or loudspeaker rendering on the fifth audio signal to obtain the rendered audio signal.

In a possible design, the rendering module is configured to perform signal format conversion on the to-be-rendered audio signal based on the control information, to obtain a sixth audio signal; and perform binaural rendering or loudspeaker rendering on the sixth audio signal to obtain the rendered audio signal.

The signal format conversion includes at least one of converting a sound-channel-based audio signal in the to-be-rendered audio signal into a scene-based or object-based audio signal; converting a scene-based audio signal in the to-be-rendered audio signal into a sound-channel-based or object-based audio signal; or converting an object-based audio signal in the to-be-rendered audio signal into a sound-channel-based or scene-based audio signal.

In a possible design, the rendering module is configured to perform signal format conversion on the to-be-rendered audio signal based on the control information, the signal format of the to-be-rendered audio signal, and processing performance of a terminal device.

In a possible design, the rendering module is configured to obtain second reverberation information, where the second reverberation information is reverberation information of a scene of the rendered audio signal, and the second reverberation information includes at least one of second reverberation output loudness information, information about a time difference between a second direct sound and an early reflected sound, second reverberation duration information, second room shape and size information, or second sound scattering degree information; perform local reverberation processing on the to-be-rendered audio signal based on the control information and the second reverberation information to obtain a seventh audio signal; and perform binaural rendering or loudspeaker rendering on the seventh audio signal to obtain the rendered audio signal.

In a possible design, the rendering module is configured to perform real-time 3DoF processing, 3DoF+ processing, or 6DoF processing on an audio signal in each signal format of the to-be-rendered audio signal based on the control information, to obtain an eighth audio signal; and perform binaural rendering or loudspeaker rendering on the eighth audio signal to obtain the rendered audio signal.

In a possible design, the rendering module is configured to perform dynamic range compression on the to-be-rendered audio signal based on the control information to obtain a ninth audio signal; and perform binaural rendering or loudspeaker rendering on the ninth audio signal to obtain the rendered audio signal.

According to a third aspect, an embodiment of this application provides an audio signal rendering apparatus including a non-volatile memory and a processor that are coupled to each other. The processor invokes program code stored in the memory to perform the method according to any one of the first aspect or the possible designs of the first aspect.

According to a fourth aspect, an embodiment of this application provides an audio signal decoding device including a renderer. The renderer is configured to perform the method according to any one of the first aspect or the possible designs of the first aspect.

According to a fifth aspect, an embodiment of this application provides a computer-readable storage medium including a computer program. When the computer program is executed on a computer, the computer is enabled to perform the method according to any one of the first aspect.

According to a sixth aspect, this application provides a computer program product. The computer program product includes a computer program. When the computer program is executed by a computer, the method according to any one of the first aspect is performed.

According to a seventh aspect, this application provides a chip. The chip includes a processor and a memory. The memory is configured to store a computer program, and the processor is configured to invoke and run the computer program stored in the memory, to perform the method according to any one of the first aspect.

According to the audio signal rendering method and apparatus in embodiments of this application, the to-be-rendered audio signal is obtained by decoding the received bitstream, and the control information is obtained. The control information indicates at least one of the content description metadata, the rendering format flag information, the loudspeaker configuration information, the application scene information, the tracking information, the posture information, or the location information. The to-be-rendered audio signal is rendered based on the control information to obtain the rendered audio signal. A rendering manner can be adaptively selected based on at least one piece of input information of the content description metadata, the rendering format flag information, the loudspeaker configuration information, the application scene information, the tracking information, the posture information, or the location information, thereby improving audio rendering effect.

### BRIEF DESCRIPTION OF DRAWINGS

FIG. 1 is a schematic diagram of an example of an audio encoding and decoding system according to an embodiment of this application;

FIG. 2 is a schematic diagram of an audio signal rendering application according to an embodiment of this application;

FIG. 3 is a flowchart of an audio signal rendering method according to an embodiment of this application;

FIG. 4 is a schematic diagram of a layout of a loudspeaker according to an embodiment of this application;

FIG. 5 is a schematic diagram of generating control information according to an embodiment of this application;

FIG. 6A is a flowchart of another audio signal rendering method according to an embodiment of this application;

FIG. 6B is a schematic diagram of rendering pre-processing according to an embodiment of this application;

FIG. 7 is a schematic diagram of loudspeaker rendering according to an embodiment of this application;

FIG. 8 is a schematic diagram of binaural rendering according to an embodiment of this application;

FIG. 9A is a flowchart of another audio signal rendering method according to an embodiment of this application;

FIG. 9B is a schematic diagram of signal format conversion according to an embodiment of this application;

FIG. 10A is a flowchart of another audio signal rendering method according to an embodiment of this application;

FIG. 10B is a schematic diagram of local reverberation processing according to an embodiment of this application;

FIG. 11A is a flowchart of another audio signal rendering method according to an embodiment of this application;

FIG. 11B is a schematic diagram of grouped source transformation according to an embodiment of this application;

FIG. 12A is a flowchart of another audio signal rendering method according to an embodiment of this application;

FIG. 12B is a schematic diagram of dynamic range compression according to an embodiment of this application;

FIG. 13A is a schematic diagram of an architecture of an audio signal rendering apparatus according to an embodiment of this application;

FIG. 13B to FIG. 13D are a schematic diagram of a detailed architecture of an audio signal rendering apparatus according to an embodiment of this application;

FIG. 14 is a schematic diagram of a structure of an audio signal rendering apparatus according to an embodiment of this application; and

FIG. 15 is a schematic diagram of a structure of an audio signal rendering device according to an embodiment of this application.

### DESCRIPTION OF EMBODIMENTS

Terms such as “first” and “second” in embodiments of this application are only used for distinguishment and description, but cannot be understood as indicating or implying relative importance or a sequence. In addition, the terms “include”, “have”, and any variant thereof are intended to cover non-exclusive inclusion, for example, include a series of steps or units. Methods, systems, products, or devices are not necessarily limited to those steps or units that are literally listed, but may include other steps or units that are not literally listed or that are inherent to such processes, methods, products, or devices.

It should be understood that in this application, “at least one (item)” refers to one or more and “a plurality of” refers to two or more. The term “and/or” is used for describing an association relationship between associated objects, and represents that three relationships may exist. For example, “A and/or B” may represent the following three cases: Only A exists, only B exists, and both A and B exist, where A and B may be singular or plural. The character “/” generally indicates an “or” relationship between the associated objects. “At least one of the following” or a similar expression thereof indicates any combination of the following, including any combination of one or more of the following. For example, at least one of a, b, or c may represent: a, b, c, “a and b”, “a and c”, “b and c”, or “a, b and c”. Each of a, b, and c may be single or plural. Alternatively, some of a, b, and c may be single; and some of a, b, and c may be plural.

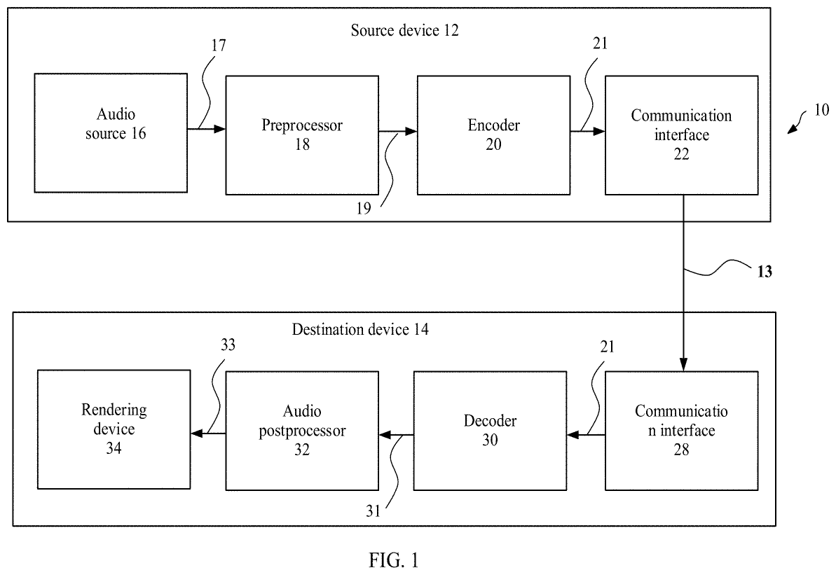

The following describes a system architecture to which embodiments of this application are applied. FIG. 1 is a schematic block diagram of an example of an audio encoding and decoding system 10 to which embodiments of this application are applied. As shown in FIG. 1, the audio encoding and decoding system 10 may include a source device 12 and a destination device 14. The source device 12 generates encoded audio data. Therefore, the source device 12 may be referred to as an audio encoding apparatus. The destination device 14 can decode the encoded audio data generated by the source device 12. Therefore, the destination device 14 may be referred to as an audio decoding apparatus. In various implementation solutions, the source device 12, the destination device 14, or both the source device 12 and the destination device 14 may include one or more processors and a memory coupled to the one or more processors. The memory may include but is not limited to a random-access memory (RAM), a read-only memory (ROM), an electrically erasable programmable ROM (EEPROM), a flash memory, or any other medium that can be used to store desired program code in a form of an instruction or a data structure accessible by a computer, as described in this specification. The source device 12 and the destination device 14 may include various apparatuses including a desktop computer, a mobile computing apparatus, a notebook (for example, a laptop) computer, a tablet computer, a set-top box, a telephone handset such as a so-called “smart” phone, a television, a sound box, a digital media player, a video game console, a vehicle-mounted computer, a wireless communication device, any wearable device (for example, a smartwatch or smart glasses), or the like.

Although FIG. 1 depicts the source device 12 and the destination device 14 as separate devices, a device embodiment may alternatively include both the source device 12 and the destination device 14 or functionalities of both the source device 12 and the destination device 14, that is, the source device 12 or a corresponding functionality and the destination device 14 or a corresponding functionality. In such an embodiment, the source device 12 or the corresponding functionality and the destination device 14 or the corresponding functionality may be implemented by using same hardware and/or software or by using separate hardware and/or software or any combination thereof.

A communication connection between the source device 12 and the destination device 14 may be implemented over a link 13, and the destination device 14 may receive the encoded audio data from the source device 12 over the link 13. The link 13 may include one or more media or apparatuses capable of translating the encoded audio data from the source device 12 to the destination device 14. In an example, the link 13 may include one or more communication media that enable the source device 12 to directly transmit the encoded audio data to the destination device 14 in real time. In this example, the source device 12 can modulate the encoded audio data according to a communication standard (for example, a wireless communication protocol), and can transmit modulated audio data to the destination device 14. The one or more communication media may include a wireless communication medium and/or a wired communication medium, for example, a radio frequency (RF) spectrum or one or more physical transmission lines. The one or more communication media may form a part of a packet-based network, and the packet-based network is, for example, a local area network, a wide area network, or a global network (for example, the internet). The one or more communication media may include a router, a switch, a base station, or another device that facilitates communication from the source device 12 to the destination device 14.

The source device 12 includes an encoder 20. Optionally, the source device 12 may further include an audio source 16, a preprocessor 18, and a communication interface 22. In a specific implementation form, the encoder 20, the audio source 16, the preprocessor 18, and the communication interface 22 may be hardware components in the source device 12, or may be software programs in the source device 12. They are separately described as follows.

The audio source 16 may include or may be a sound capture device of any type, configured to capture, for example, sound from the real world, and/or an audio generation device of any type. The audio source 16 may be a microphone configured to capture sound or a memory configured to store audio data, and the audio source 16 may further include any type of (internal or external) interface for storing previously captured or generated audio data and/or for obtaining or receiving audio data. When the audio source 16 is a microphone, the audio source 16 may be, for example, a local microphone or a microphone integrated into the source device. When the audio source 16 is a memory, the audio source 16 may be, for example, a local memory or a memory integrated into the source device. When the audio source 16 includes an interface, the interface may be, for example, an external interface for receiving audio data from an external audio source. For example, the external audio source is an external sound capture device such as a microphone, an external storage, or an external audio generation device. The interface may be any type of interface, for example, a wired or wireless interface or an optical interface, according to any proprietary or standardized interface protocol.

In this embodiment of this application, the audio data transmitted by the audio source 16 to the preprocessor 18 may also be referred to as raw audio data 17.

The preprocessor 18 is configured to receive and preprocess the raw audio data 17, to obtain preprocessed audio 19 or preprocessed audio data 19. For example, preprocessing performed by the preprocessor 18 may include filtering or denoising.

The encoder 20 (or referred to as an audio encoder 20) is configured to receive the preprocessed audio data 19, and process the preprocessed audio data 19 to provide encoded audio data 21.

The communication interface 22 may be configured to receive the encoded audio data 21, and transmit the encoded audio data 21 to the destination device 14 or any other device (for example, a memory) over the link 13 for storage or direct reconstruction. The other device may be any device used for decoding or storage. The communication interface 22 may be, for example, configured to encapsulate the encoded audio data 21 into an appropriate format, for example, a data packet, for transmission over the link 13.

The destination device 14 includes a decoder 30. In addition, optionally, the destination device 14 may further include a communication interface 28, an audio postprocessor 32, and a rendering device 34. They are separately described as follows.

The communication interface 28 may be configured to receive the encoded audio data 21 from the source device 12 or any other source. The any other source is, for example, a storage device. The storage device is, for example, an encoded audio data storage device. The communication interface 28 may be configured to transmit or receive the encoded audio data 21 over the link 13 between the source device 12 and the destination device 14 or through any type of network. The link 13 is, for example, a direct wired or wireless connection. The any type of network is, for example, a wired or wireless network or any combination thereof, or any type of private or public network, or any combination thereof. The communication interface 28 may be, for example, configured to decapsulate the data packet transmitted through the communication interface 22, to obtain the encoded audio data 21.

Both the communication interface 28 and the communication interface 22 may be configured as unidirectional communication interfaces or bidirectional communication interfaces, and may be configured to, for example, send and receive messages to establish a connection, and acknowledge and exchange any other information related to a communication link and/or data transmission such as encoded audio data transmission.

The decoder 30 (or referred to as an audio decoder 30) is configured to receive the encoded audio data 21 and provide decoded audio data 31 or decoded audio 31.

The audio postprocessor 32 is configured to postprocess the decoded audio data 31 (also referred to as reconstructed audio data) to obtain postprocessed audio data 33. Postprocessing performed by the audio postprocessor 32 may include, for example, rendering or any other processing, and may be further configured to transmit the postprocessed audio data 33 to the rendering device 34. The audio postprocessor may be configured to perform various embodiments described below, to implement application of an audio signal rendering method described in this application.

The rendering device 34 is configured to receive the postprocessed audio data 33 to play audio to, for example, a user or a viewer. The rendering device 34 may be or may include any type of audio player configured to present reconstructed sound. The rendering device may include a loudspeaker or a headphone.

As will be apparent for a person skilled in the art based on the descriptions, existence and (exact) split of functionalities of the different units or functionalities of the source device 12 and/or the destination device 14 shown in FIG. 1 may vary depending on an actual device and application. The source device 12 and the destination device 14 may be any one of a wide range of devices, including any type of handheld or stationary device, for example, a notebook or laptop computer, a mobile phone, a smartphone, a pad or a tablet computer, a video camera, a desktop computer, a set-top box, a television, a camera, a vehicle-mounted device, a sound box, a digital media player, a video game console, a video streaming transmission device (such as a content service server or a content distribution server), a broadcast receiver device, a broadcast transmitter device, smart glasses, or a smart watch, and may not use or may use any type of operating system.

The encoder 20 and the decoder 30 each may be implemented as any one of various appropriate circuits, for example, one or more microprocessors, digital signal processors (DSPs), application-specific integrated circuits (ASICs), field-programmable gate arrays (FPGAs), discrete logic, hardware, or any combinations thereof. If the technologies are implemented partially by using software, a device may store software instructions in an appropriate and non-transitory computer-readable storage medium and may execute instructions by using hardware such as one or more processors, to perform the technologies of this disclosure. Any one of the foregoing content (including hardware, software, a combination of hardware and software, and the like) may be considered as one or more processors.

In some cases, the audio encoding and decoding system 10 shown in FIG. 1 is merely an example, and the technologies of this application is applicable to audio encoding settings (for example, audio encoding or audio decoding) that do not necessarily include any data communication between an encoding device and a decoding device. In another example, data may be retrieved from a local memory, transmitted in a streaming manner through a network, or the like. An audio encoding device may encode data and store data into the memory, and/or an audio decoding device may retrieve and decode data from the memory. In some examples, the encoding and the decoding are performed by devices that do not communicate with one another, but simply encode data to the memory and/or retrieve and decode data from the memory.

The encoder may be a multi-channel encoder, for example, a stereo encoder, a 5.1-channel encoder, or a 7.1-channel encoder. Certainly, it may be understood that the encoder may also be a mono encoder. The audio postprocessor may be configured to perform the following audio signal rendering method in embodiments of this application, to improve audio playing effect.

The audio data may also be referred to as an audio signal, the decoded audio data may also be referred to as a to-be-rendered audio signal, and the postprocessed audio data may also be referred to as a rendered audio signal. The audio signal in embodiments of this application is an input signal of an audio rendering apparatus. The audio signal may include a plurality of frames. For example, a current frame may specifically refer to a frame in the audio signal. In embodiments of this application, rendering of an audio signal of the current frame is used as an example for description. Embodiments of this application are used to implement rendering of the audio signal.

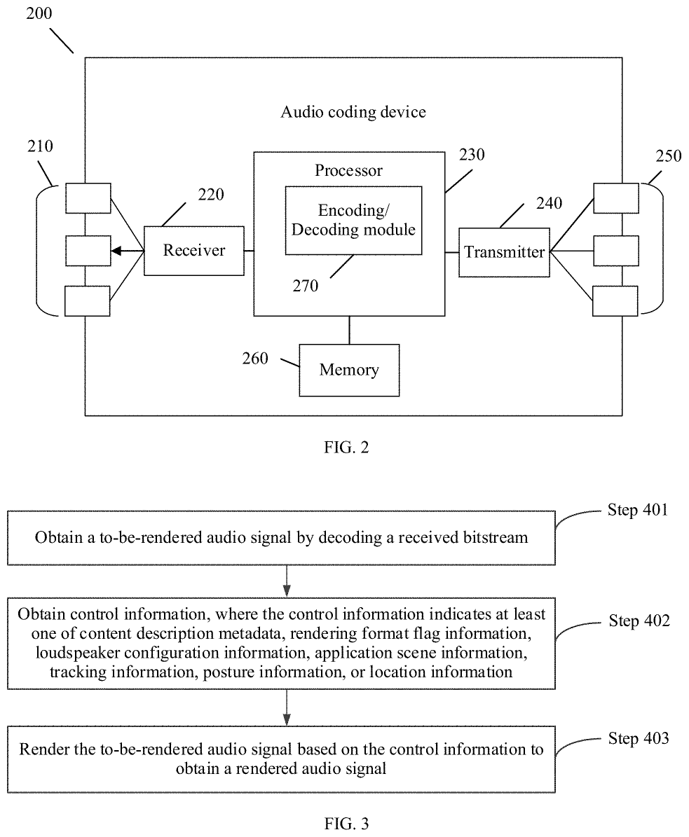

FIG. 2 is a simplified block diagram of an apparatus 200 according to an example embodiment. The apparatus 200 can implement technologies of this application. In other words, FIG. 2 is a schematic block diagram of an implementation of an encoding device or a decoding device (briefly referred to as a coding device 200) according to this application. The apparatus 200 may include a processor 210, a memory 230, and a bus system 250. The processor and the memory are connected through the bus system. The memory is configured to store instructions. The processor is configured to execute the instructions stored in the memory. The memory of the coding device stores program code. The processor may invoke the program code stored in the memory to perform the method described in this application. To avoid repetition, details are not described herein again.

In this application, the processor 210 may be a central processing unit (CPU), or the processor 210 may be another general-purpose processor, a DSP, an ASIC, an FPGA or another programmable logic device, discrete gate or transistor logic device, discrete hardware component, or the like. The general-purpose processor may be a microprocessor, or the processor may be any conventional processor or the like.

The memory 230 may include a ROM device or a RAM device. Any other proper type of storage device may also be used as the memory 230. The memory 230 may include code and data 231 that are accessed by the processor 210 through the bus system 250. The memory 230 may further include an operating system 233 and an application 235.

In addition to a data bus, the bus system 250 may further include a power bus, a control bus, a status signal bus, and the like. However, for clear description, all types of buses are marked as the bus system 250 in FIG. 2.

Optionally, the coding device 200 may further include one or more output devices, for example, a loudspeaker 270. In an example, the loudspeaker 270 may be a headphone or an external play device. The loudspeaker 270 may be connected to the processor 210 through the bus system 250.

The audio signal rendering method in embodiments of this application is applicable to audio rendering in voice communication in any communication system. The communication system may be a Long-Term Evolution (LTE) system, a fifth-generation (5G) system, a future evolved public land mobile network (PLMN) system, or the like. The audio signal rendering method in embodiments of this application is also applicable to audio rendering in VR, augmented reality (AR), or an audio playing application. Certainly, the audio signal rendering method in embodiments of this application may be alternatively applicable to another application scene of audio signal rendering. Examples are not enumerated in embodiments of this application.

VR is used as an example. At an encoder side, a preprocessing operation (Audio Preprocessing) is performed after an acquisition module obtains an audio signal A, where the preprocessing operation includes filtering out a low frequency part in the signal, generally using 20 hertz (Hz) or 50 Hz as a boundary point, extracting orientation information from the audio signal. Then, encoding processing (Audio encoding) and encapsulation (File/Segment encapsulation) are performed. Then, a bitstream obtained through encoding processing (Audio encoding) and encapsulation (File/Segment encapsulation) is delivered (Delivery) to a decoder side. The decoder side first performs decapsulation (File/Segment decapsulation), then performs decoding (Audio decoding), performs rendering (Audio rendering) processing on a decoded signal, and maps a signal obtained through the rendering processing to a headphone (headphones) or a loudspeaker (loudspeakers) of a listener. The headphone may be an independent headphone, or may be a headphone on an eyeglass device or another wearable device. The rendering (Audio rendering) processing may be performed on the decoded signal by using the audio signal rendering method described in the following embodiments.

The audio signal rendering in embodiments of this application refers to converting a to-be-rendered audio signal into an audio signal in a specific playing format, that is, a rendered audio signal such that the rendered audio signal adapts to at least one of a playback environment or a playback device, thereby improving user auditory experience. The playback device may be the foregoing rendering device 34, and may include a headphone or a loudspeaker. The playback environment may be an environment in which the playback device is located. For a specific processing manner for the audio signal rendering, refer to descriptions in the following embodiments.

An audio signal rendering apparatus may perform the audio signal rendering method in embodiments of this application, to adaptively select a rendering processing manner, thereby improving rendering effect of an audio signal. The audio signal rendering apparatus may be the audio postprocessor in the foregoing destination device. The destination device may be any terminal device, for example, may be a mobile phone, a wearable device, a VR device, or an AR device. For a specific implementation of the destination device, refer to the following specific descriptions of an embodiment shown in FIG. 3. The destination device may also be referred to as a replaying end, a playback end, a rendering end, a decoding and rendering end, or the like.

FIG. 3 is a flowchart of an audio signal rendering method according to an embodiment of this application. This embodiment of this application may be executed by the foregoing audio signal rendering apparatus. As shown in FIG. 3, the method in this embodiment may include the following steps.

Step 401: Obtain a to-be-rendered audio signal by decoding a received bitstream.

The to-be-rendered audio signal is obtained by decoding the received bitstream. A signal format of the to-be-rendered audio signal may include one signal format or a combination of a plurality of signal formats, and the signal format may include a sound-channel-based signal format, a scene-based signal format, an object-based signal format, or the like.

Among the three different signal formats, the sound-channel-based signal format is the most conventional audio signal format, which is easy to store and transmit, and can be directly replayed by using a loudspeaker without much additional processing. In other words, the sound-channel-based audio signal is for some standard loudspeaker arrangements, such as a 5.1 sound channel loudspeaker arrangement and a 7.1.4 sound channel loudspeaker arrangement. One sound channel signal corresponds to one loudspeaker device. In actual application, if a loudspeaker configuration format is different from a loudspeaker configuration format required by the to-be-rendered audio signal, upmixing (upmix) or downmixing (downmix) processing needs to be performed to adapt to a currently applied loudspeaker configuration format. The downmixing processing reduces accuracy of a sound image in a replayed sound field to some extent. For example, the sound-channel-based signal format is compliant with the 7.1.4 sound channel loudspeaker arrangement, but the currently applied loudspeaker configuration format is a 5.1 sound channel loudspeaker. Therefore, a 7.1.4 sound channel signal needs to be downmixed to obtain a 5.1 sound channel signal, so that the 5.1 sound channel loudspeaker can be used for playback. If a headphone needs to be used for playback, head related transfer function (HRTF)/BRIR convolution processing may be further performed on a loudspeaker signal to obtain a binaural rendered signal, and binaural playback is performed by using a device such as the headphone. The sound-channel-based audio signal may be a mono audio signal, or may be a multi-channel signal, for example, a stereo signal.

The object-based signal format is used to describe object audio, and includes a series of sound objects and corresponding metadata. The sound objects include independent sound sources. The metadata includes static metadata such as a language and a start time, and dynamic metadata such as locations, orientations, and sound pressures (level) of the sound sources. Therefore, a greatest advantage of the object-based signal format is that the object-based signal format can be used in any loudspeaker replay system for selective replay, and interactivity is simultaneously increased. For example, a language is adjusted, volumes of some sound sources are increased, and a location of a sound source object is adjusted based on translation of a listener.

In the scene-based signal format, an actual physical sound signal or a sound signal acquired by a microphone is expanded by using an orthogonal basis function, and a corresponding basis function expansion coefficient instead of a direct loudspeaker signal is stored. At a replaying end, binaural rendering and replay are performed by using a corresponding sound field synthesis algorithm. A plurality of loudspeaker configurations for replay may alternatively be used, and loudspeaker placement is flexible. The scene-based audio signal may include a first-order Ambisonics (FOA) signal, a high-order Ambisonics (HOA) signal, or the like.

The signal format is a signal format obtained by an acquisition end. For example, in an application scene of a multi-party remote conference call, some terminal devices send stereo signals, that is, sound-channel-based audio signals, some terminal devices send object-based audio signals of a remote participant, and some terminal devices send HOA signals, that is, scene-based audio signals. The replaying end decodes the received bitstream to obtain the to-be-rendered audio signal, where the to-be-rendered audio signal is a mixed signal of three signal formats. The audio signal rendering apparatus in embodiments of this application may support flexible rendering of an audio signal of one or more signal formats.

Content description metadata may further be obtained by decoding the received bitstream. The content description metadata indicates the signal format of the to-be-rendered audio signal. For example, in the foregoing application scene of the multi-party remote conference call, the replaying end may obtain the content description metadata through decoding, where the content description metadata indicates that the signal format of the to-be-rendered audio signal includes three signal formats: the sound-channel-based signal format, the object-based signal format, and the scene-based signal format.

Step 402: Obtain control information, where the control information indicates at least one of the content description metadata, rendering format flag information, loudspeaker configuration information, application scene information, tracking information, posture information, or location information.

The foregoing content description metadata indicates the signal format of the to-be-rendered audio signal, and the signal format includes at least one of the sound-channel-based signal format, the scene-based signal format, or the object-based signal format.

The rendering format flag information indicates an audio signal rendering format. The audio signal rendering format may include loudspeaker rendering or binaural rendering. In other words, the rendering format flag information indicates an audio rendering apparatus to output a loudspeaker rendered signal or a binaural rendered signal. The rendering format flag information may be obtained from the bitstream received through decoding, or may be determined based on hardware configuration of the replaying end, or may be obtained based on configuration information of the replaying end.

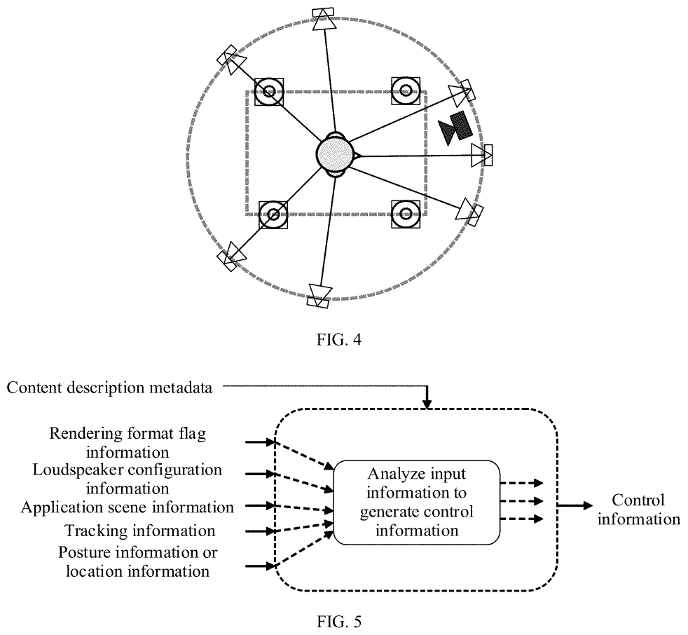

The loudspeaker configuration information indicates a layout of the loudspeaker. The layout of the loudspeaker may include a location of the loudspeaker and a quantity of loudspeakers. The layout of the loudspeaker enables the audio rendering apparatus to generate a loudspeaker rendered signal of a corresponding layout. FIG. 4 is a schematic diagram of a layout of a loudspeaker according to an embodiment of this application. As shown in FIG. 4, eight loudspeakers on a horizontal plane form a configuration of a 7.1 layout, where a solid loudspeaker represents a heavy bass loudspeaker, and four loudspeakers (the four loudspeakers in dashed boxes in FIG. 4) on a plane above the horizontal plane form a 7.1.4 loudspeaker layout. Loudspeaker configuration information may be determined based on a loudspeaker layout of the replaying end, or may be obtained from the configuration information of the replaying end.

The application scene information indicates renderer scene description information. The renderer scene description information may indicate a scene in which a rendered audio signal is output, that is, a rendering sound field environment. The scene may be at least one of an indoor conference room, an indoor classroom, an outdoor grass, a concert performance site, or the like. The application scene information may be determined based on information obtained by a sensor of the replaying end. For example, one or more sensors such as an ambient light sensor and an infrared sensor are used to acquire environment data of the replaying end, and the application scene information is determined based on the environment data. For another example, the application scene information may be determined based on an access point (AP) connected to the replaying end. For example, the AP is home Wi-Fi, and when the replaying end is connected to home Wi-Fi, it may be determined that the application scene information is home indoor. For another example, the application scene information may be obtained from the configuration information of the replaying end.

The tracking information indicates whether the rendered audio signal changes with head rotation of the listener. The tracing information may be obtained from the configuration information of the replaying end. The posture information indicates an orientation and an amplitude of the head rotation. The posture information may be 3DoF data. The 3DoF data indicates information about the head rotation of the listener. The 3DoF data may include three rotation angles of the head. The posture information may be 3DoF+ data, and the 3DoF+ data indicates translation information of forward, backward, left, and right translation of an upper body when the listener sits in a seat and does not translate. The 3DoF+ data may include the three rotation angles of the head, amplitudes of forward and backward translation of the upper body, and amplitudes of left and right translation of the upper body. Alternatively, the 3DoF+ data may include the three rotation angles of the head and amplitudes of forward and backward translation of the upper body. Alternatively, the 3DoF+ data may include the three rotation angles of the head and amplitudes of left and right translation of the upper body. The location information indicates an orientation and an amplitude of body translation of the listener. The posture information and the location information may be 6DoF data, and the 6DoF data indicates information about unconstrained free translation of the listener. The 6DoF data may include the three rotation angles of the head, amplitudes of forward and backward body translation, amplitudes of left and right body translation, and amplitudes of up and down body translation.

A manner of obtaining the control information may be that the audio signal rendering apparatus generates the control information based on at least one of the content description metadata, the rendering format flag information, the loudspeaker configuration information, the application scene information, the tracking information, the posture information, or the location information. Alternatively, the control information may be obtained by receiving the control information from another device. A specific implementation of obtaining the control information is not limited in this embodiment of this application.

For example, before rendering processing is performed on the to-be-rendered audio signal, in this embodiment of this application, the control information may be generated based on at least one of the content description metadata, the rendering format flag information, the loudspeaker configuration information, the application scene information, the tracking information, the posture information, or the location information. Refer to FIG. 5. Input information includes at least one of the foregoing content description metadata, rendering format flag information, loudspeaker configuration information, application scene information, tracking information, posture information, or location information, and the input information is analyzed to generate the control information. The control information may be used for rendering processing, so that a rendering processing manner can be adaptively selected, thereby improving rendering effect of an audio signal. The control information may include a rendering format of an output signal (that is, the rendered audio signal), the application scene information, a used rendering processing manner, a database used for rendering, and the like.

Step 403: Render the to-be-rendered audio signal based on the control information to obtain the rendered audio signal.

Because the control information is generated based on at least one of the foregoing content description metadata, rendering format flag information, loudspeaker configuration information, application scene information, tracking information, posture information, or location information, rendering is performed in a corresponding rendering manner based on the control information, to adaptively select a rendering manner based on the input information, thereby improving audio rendering effect.

In some embodiments, the foregoing step 403 may include at least one of performing rendering pre-processing on the to-be-rendered audio signal based on the control information; performing signal format conversion on the to-be-rendered audio signal based on the control information; performing local reverberation processing on the to-be-rendered audio signal based on the control information; performing grouped source transformation on the to-be-rendered audio signal based on the control information; performing dynamic range compression on the to-be-rendered audio signal based on the control information; performing binaural rendering on the to-be-rendered audio signal based on the control information; or performing loudspeaker rendering on the to-be-rendered audio signal based on the control information.

The rendering pre-processing is used to perform static initialization processing on the to-be-rendered audio signal by using related information of a transmit end, and the related information of the transmit end may include reverberation information of the transmit end. The rendering pre-processing may provide a basis for one or more subsequent dynamic rendering processing manners such as signal format conversion, local reverberation processing, grouped source transformation, dynamic range compression, binaural rendering, or loudspeaker rendering such that the rendered audio signal matches at least one of a playback device or a playback environment, thereby providing good auditory effect. For a specific implementation of the rendering pre-processing, refer to descriptions of an embodiment shown in 6B.

The grouped source transformation is used to perform real-time 3DoF processing, 3DoF+ processing, or 6DoF processing on an audio signal in each signal format of the to-be-rendered audio signal, in other words, perform same processing on audio signals in a same signal format, to reduce processing complexity. For a specific implementation of the grouped source transformation, refer to descriptions of an embodiment shown in 11B.

The dynamic range compression is used to compress a dynamic range of the to-be-rendered audio signal, to improve playing quality of the rendered audio signal. The dynamic range is a strength difference between a strongest signal and a weakest signal in the rendered audio signal, and is expressed in a unit of “decibels (db)”. For a specific implementation of the dynamic range compression, refer to descriptions of an embodiment shown in 12B.

The binaural rendering is used to convert the to-be-rendered audio signal into a binaural signal for playback by using a headphone. For a specific implementation of the binaural rendering, refer to descriptions of step 504 in the embodiment shown in 6A.

The loudspeaker rendering is used to convert the to-be-rendered audio signal into a signal that matches the loudspeaker layout for playback by using the loudspeaker. For a specific implementation of the loudspeaker rendering, refer to the descriptions of step 504 in the embodiment shown in 6A.

For example, a specific implementation of rendering the to-be-rendered audio signal based on the control information is described by using an example in which the control information indicates three pieces of information: the content description metadata, the rendering format flag information, and tracking information. In an example, the content description metadata indicates that an input signal format is a scene-based audio signal, the rendered format flag information indicates that rendering is binaural rendering, and the tracking information indicates that the rendered audio signal does not change with the head rotation of the listener. In this case, the rendering the to-be-rendered audio signal based on the control information may be: converting the scene-based audio signal into a sound-channel-based audio signal, and directly convolving the sound-channel-based audio signal by using head-related transfer function (HRTF)/binaural room impulse response (BRIR) to generate a binaural rendered signal, where the binaural rendered signal is a rendered audio signal. In another example, the content description metadata indicates that an input signal format is a scene-based audio signal, the rendered format flag information indicates that rendering is binaural rendering, and the tracking information indicates that the rendered audio signal changes with the head rotation of the listener. In this case, rendering the to-be-rendered audio signal based on the control information may be performing spherical harmonic decomposition on the scene-based audio signal to generate a virtual loudspeaker signal, and convolving the virtual loudspeaker signal by using HRTF/BRIR to generate a binaural rendered signal, where the binaural rendered signal is a rendered audio signal. In a still another example, the content description metadata indicates that an input signal format is a sound-channel-based audio signal, the rendered format flag information indicates that rendering is binaural rendering, and the tracking information indicates that the rendered audio signal does not change with the head rotation of the listener. In this case, the rendering the to-be-rendered audio signal based on the control information may be generating a binaural rendered signal by directly convolving the sound-channel-based audio signal by using HRTF/BRIR, where the binaural rendered signal is a rendered audio signal. In a yet another example, the content description metadata indicates that an input signal format is a sound-channel-based audio signal, the rendered format flag information indicates that rendering is binaural rendering, and the tracking information indicates that the rendered audio signal changes with the head rotation of the listener. In this case, rendering the to-be-rendered audio signal based on the control information may be converting the sound-channel-based audio signal into a scene-based audio signal, performing spherical harmonic decomposition on the scene-based audio signal to generate a virtual loudspeaker signal, and convolving the virtual loudspeaker signal by using HRTF/BRIR to generate a binaural rendered signal, where the binaural rendered signal is a rendered audio signal. It should be noted that the foregoing examples are merely examples, and it is not limited that only the foregoing examples can be used in actual application. In this way, an appropriate processing manner is adaptively selected based on information indicated by the control information to render an input signal, to improve rendering effect.

For example, the control information indicates the content description metadata, the rendering format flag information, the application scene information, the tracking information, the posture information, and location information. A specific implementation of rendering the to-be-rendered audio signal based on the control information may be performing local reverberation processing, grouped source transformation, and binaural rendering or loudspeaker rendering on the to-be-rendered audio signal based on the content description metadata, the rendering format flag information, the application scene information, the tracking information, the posture information, and the location information; or performing signal format conversion, local reverberation processing, grouped source transformation, and binaural rendering or loudspeaker rendering on the to-be-rendered audio signal based on the content description metadata, the rendering format flag information, the application scene information, the tracking information, the posture information, and the location information. In this way, an appropriate processing manner is adaptively selected based on information indicated by the control information to render an input signal, to improve rendering effect. It should be noted that the foregoing example is merely an example, and it is not limited that only the foregoing example can be used in actual application.

In this embodiment, the to-be-rendered audio signal is obtained by decoding the received bitstream, and the control information is obtained. The control information indicates at least one of the content description metadata, the rendering format flag information, the loudspeaker configuration information, the application scene information, the tracking information, the posture information, or the location information. The to-be-rendered audio signal is rendered based on the control information to obtain the rendered audio signal. A rendering manner can be adaptively selected based on at least one piece of input information of the content description metadata, the rendering format flag information, the loudspeaker configuration information, the application scene information, the tracking information, the posture information, or the location information, thereby improving audio rendering effect.

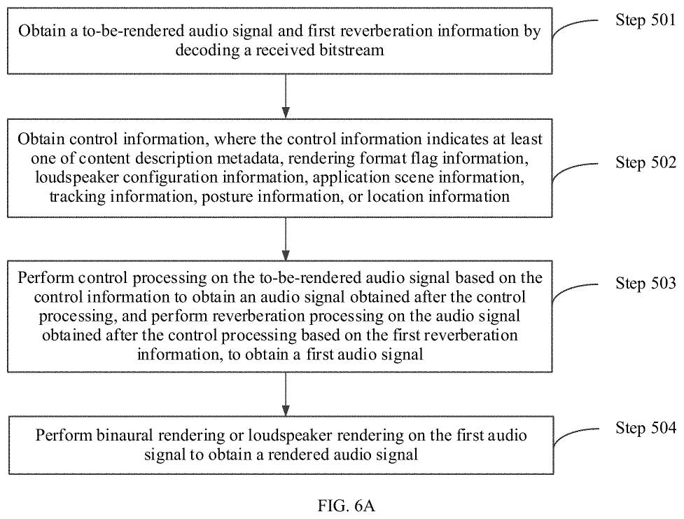

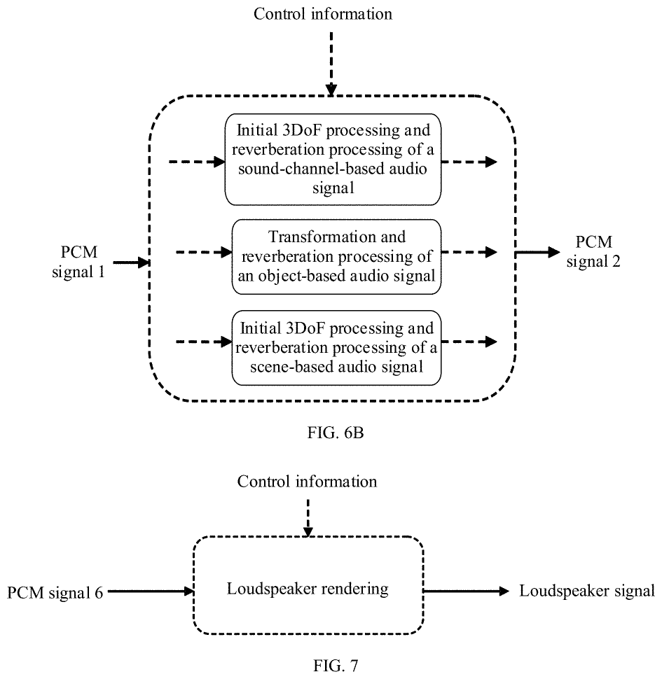

FIG. 6A is a flowchart of another audio signal rendering method according to an embodiment of this application. FIG. 6B is a schematic diagram of rendering pre-processing according to an embodiment of this application. This embodiment of this application may be executed by the foregoing audio signal rendering apparatus. This embodiment is an implementation of the embodiment shown in FIG. 3, that is, specifically describes rendering pre-processing processing of the audio signal rendering method in embodiments of this application. The rendering pre-processing includes performing precision setting of rotation and translation on a sound-channel-based audio signal, an object-based audio signal, or a scene-based audio signal, and completing 3DoF processing and reverberation processing. As shown in FIG. 6A, the method in this embodiment may include the following steps.

Step 501: Obtain a to-be-rendered audio signal and first reverberation information by decoding a received bitstream.

The to-be-rendered audio signal includes at least one of a sound-channel-based audio signal, an object-based audio signal, or a scene-based audio signal, and the first reverberation information includes at least one of first reverberation output loudness information, information about a time difference between a first direct sound and an early reflected sound, first reverberation duration information, first room shape and size information, or first sound scattering degree information.

Step 502: Obtain control information, where the control information indicates at least one of content description metadata, rendering format flag information, loudspeaker configuration information, application scene information, tracking information, posture information, or location information.

For descriptions of step 502, refer to specific descriptions of step 402 in the embodiment shown in FIG. 3. Details are not described herein again.

Step 503: Perform control processing on the to-be-rendered audio signal based on the control information to obtain an audio signal obtained after the control processing, and perform reverberation processing on the audio signal obtained after the control processing based on the first reverberation information, to obtain a first audio signal.

The foregoing control processing includes at least one of performing initial 3DoF processing on the sound-channel-based audio signal in the to-be-rendered audio signal, performing conversion processing on the object-based audio signal in the to-be-rendered audio signal, or performing initial 3DoF processing on the scene-based audio signal in the to-be-rendered audio signal.

In this embodiment of this application, rendering pre-processing may be separately performed on an individual source based on the control information. The individual source may be a sound-channel-based audio signal, an object-based audio signal, or a scene-based audio signal. A pulse code modulation (PCM) signal 1 is used as an example. Refer to FIG. 6B. An input signal before rendering pre-processing is the PCM signal 1, and an output signal is a PCM signal 2. If the control information indicates that a signal format of the input signal includes a sound-channel-based signal format, the rendering pre-processing includes initial 3DoF processing and reverberation processing of the sound-channel-based audio signal. If the control information indicates that a signal format of the input signal includes an object-based signal format, the rendering pre-processing includes transformation and reverberation processing of the object-based audio signal. If the control information indicates that a signal format of the input signal includes a scene-based signal format, the rendering pre-processing includes initial 3DoF processing and reverberation processing of the scene-based audio signal. The output PCM signal 2 is obtained after the rendering pre-processing.

For example, when the to-be-rendered audio signal includes the sound-channel-based audio signal and the scene-based audio signal, rendering pre-processing may be separately performed on the sound-channel-based audio signal and the scene-based audio signal based on the control information. To be specific, initial 3DoF processing is performed on the sound-channel-based audio signal based on the control information, and reverberation processing is performed on the sound-channel-based audio signal based on the first reverberation information, to obtain a sound-channel-based audio signal obtained through the rendering pre-processing; and initial 3DoF processing is performed on the scene-based audio signal based on the control information, and reverberation processing is performed on the scene-based audio signal based on the first reverberation information, to obtain a scene-based audio signal obtained through the rendering processing, where the first audio signal includes the sound-channel-based audio signal obtained through the rendering processing and the scene-based audio signal obtained through the rendering processing. When the to-be-rendered audio signal includes the sound-channel-based audio signal, the object-based audio signal, and the scene-based audio signal, a processing process of the to-be-rendered audio signal is similar to that in the foregoing example. The first audio signal obtained through rendering pre-processing may include a sound-channel-based audio signal obtained through the rendering processing, an object-based audio signal obtained through the rendering processing, and a scene-based audio signal obtained through the rendering processing. In this embodiment, the foregoing two examples are used as examples for illustration. When the to-be-rendered audio signal includes another form of audio signal in a single signal format or a combination of audio signals in a plurality of signal formats, specific implementations are similar, that is, precision settings of rotation and translation are performed on the audio signal in the single signal format, and initial 3DoF processing and reverberation processing are completed. Examples are not enumerated herein.

According to the rendering pre-processing in this embodiment of this application, a corresponding processing method may be selected based on the control information to perform rendering pre-processing on an individual source (individual sources). For the scene-based audio signal, the initial 3DoF processing may include translating and rotating the scene-based audio signal based on a start location (which is determined based on initial 3DoF data), and then performing virtual loudspeaker mapping on a processed scene-based audio signal to obtain a virtual loudspeaker signal corresponding to the scene-based audio signal. For the sound-channel-based audio signal, the sound-channel-based audio signal includes one or more sound channel signals, and the foregoing initial 3DoF processing may include calculating an initial location (which is determined based on initial 3DoF data) of a listener and a relative location of each sound channel signal to select initial HRTF/BRIR data, so as to obtain a corresponding sound channel signal and an initial HRTF/BRIR data index. For the object-based audio signal, the object-based audio signal includes one or more object signals, and the conversion processing may include calculating an initial location (which is determined based on initial 3DoF data) of a listener and a relative location of each object signal to select initial HRTF/BRIR data, so as to obtain a corresponding object signal and an initial HRTF/BRIR data index.

The foregoing reverberation processing is generating the first reverberation information based on an output parameter of a decoder, and a parameter that needs to be used in the reverberation processing includes but is not limited to one or more of reverberation output loudness information, information about a time difference between a direct sound and an early reflected sound, reverberation duration information, room shape and size information, or sound scattering degree information. Reverberation processing is separately performed on the audio signals in the three signal formats based on the first reverberation information generated in the three signal formats, to obtain an output signal that carries reverberation information of a transmit end, that is, the foregoing first audio signal.

Step 504: Perform binaural rendering or loudspeaker rendering on the first audio signal to obtain a rendered audio signal.

The rendered audio signal may be played by using a loudspeaker or a headphone.

In an implementation, loudspeaker rendering may be performed on the first audio signal based on the control information. For example, the input signal (that is, the first audio signal herein) may be processed based on the loudspeaker configuration information in the control information and the rendering format flag information in the control information. One loudspeaker rendering manner may be used for a part of signals in the first audio signal, and another loudspeaker rendering manner may be used for the other part of signals in the first audio signal. The loudspeaker rendering manner may include loudspeaker rendering of the sound-channel-based audio signal, loudspeaker rendering of the scene-based audio signal, or loudspeaker rendering of the object-based audio signal. The loudspeaker processing of the sound-channel-based audio signal may include performing upmixing or downmixing processing on the input sound-channel-based audio signal to obtain a loudspeaker signal corresponding to the sound-channel-based audio signal. The loudspeaker rendering of the object-based audio signal may include applying an amplitude translation processing method to the object-based audio signal to obtain a loudspeaker signal corresponding to the object-based audio signal. The loudspeaker rendering of the scene-based audio signal includes performing decoding processing on the scene-based audio signal, to obtain a loudspeaker signal corresponding to the scene-based audio signal. A loudspeaker signal is obtained after one or more of the loudspeaker signal corresponding to the sound-channel-based audio signal, the loudspeaker signal corresponding to the object-based audio signal, and the loudspeaker signal corresponding to the scene-based audio signal are mixed. In some embodiments, crosstalk cancellation processing may be further performed on the loudspeaker signal and height information may be further virtualized by using a loudspeaker in a horizontal location without a height loudspeaker.

An example in which the first audio signal is a PCM signal 6 is used. FIG. 7 is a schematic diagram of loudspeaker rendering according to an embodiment of this application. As shown in FIG. 7, an input of loudspeaker rendering is the PCM signal 6. After the foregoing loudspeaker rendering, a loudspeaker signal is output.

In another implementation, binaural rendering may be performed on the first audio signal based on the control information. For example, the input signal (that is, the first audio signal herein) may be processed based on the rendering format flag information in the control information. HRTF data corresponding to an initial HRTF data index may be obtained from an HRTF database based on the index obtained through the rendering pre-processing. Head-centered HRTF data is converted into binaural-centered HRTF data, and crosstalk cancellation processing, headphone equalization processing, personalized processing, and the like are performed on the HRTF data. The binaural signal processing is performed on the input signal (that is, the first audio signal herein) based on the HRTF data to obtain a binaural signal. The binaural signal processing includes: processing the sound-channel-based audio signal and the object-based audio signal by using a direct convolution method, to obtain a binaural signal; and processing the scene-based audio signal by using a spherical harmonic decomposition and convolution method, to obtain a binaural signal.

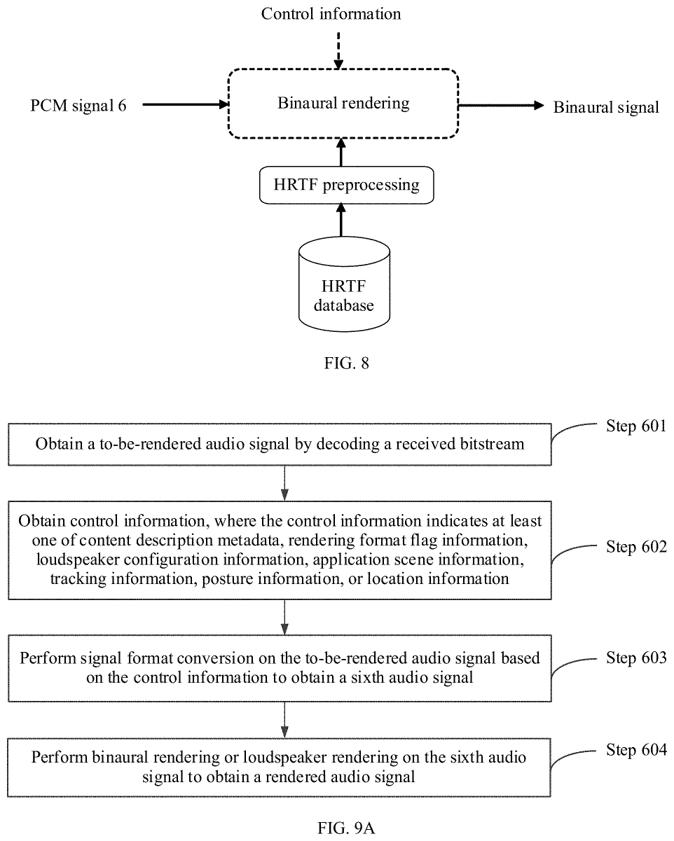

An example in which the first audio signal is a PCM signal 6 is used. FIG. 8 is a schematic diagram of binaural rendering according to an embodiment of this application. As shown in FIG. 8, an input of binaural rendering is the PCM signal 6, and after the foregoing binaural rendering, a binaural signal is output.

In this embodiment, the to-be-rendered audio signal and the first reverberation information are obtained by decoding the received bitstream, and control processing is performed on the to-be-rendered audio signal based on at least one of the content description metadata, the rendering format flag information, the loudspeaker configuration information, the application scene information, the tracking information, the posture information, or the location information indicated by the control information, to obtain the audio signal obtained through the control processing. The control processing includes at least one of performing initial 3DoF processing on the sound-channel-based audio signal, performing conversion processing on the object-based audio signal, or performing initial 3DoF processing on the scene-based audio signal, and performing, based on the first reverberation information, reverberation processing on the audio signal obtained through the control processing, to obtain the first audio signal. Binaural rendering or loudspeaker rendering is performed on the first audio signal, to obtain a rendered audio signal. A rendering manner can be adaptively selected based on at least one piece of input information of the content description metadata, the rendering format flag information, the loudspeaker configuration information, the application scene information, the tracking information, the posture information, or the location information, thereby improving audio rendering effect.

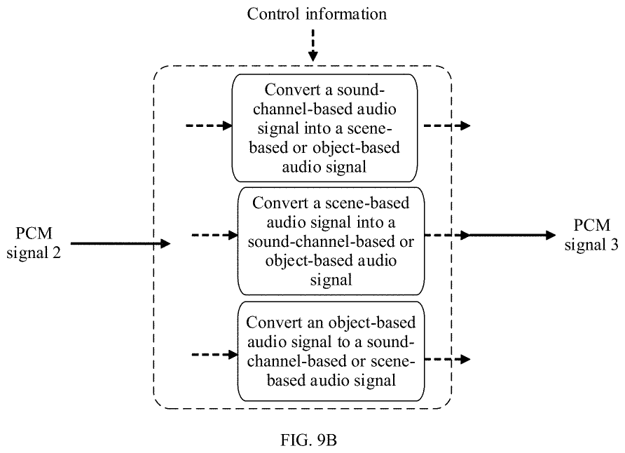

FIG. 9A is a flowchart of another audio signal rendering method according to an embodiment of this application. FIG. 9B is a schematic diagram of signal format conversion according to an embodiment of this application. This embodiment of this application may be executed by the foregoing audio signal rendering apparatus. This embodiment is an implementation of the embodiment shown in FIG. 3, that is, specifically describes signal format conversion of the audio signal rendering method in embodiments of this application. Signal format conversion may be used to convert a signal format into another signal format, to improve rendering effect. As shown in FIG. 9A, the method in this embodiment may include the following steps.

Step 601: Obtain a to-be-rendered audio signal by decoding a received bitstream.

For descriptions of step 601, refer to specific descriptions of step 401 in the embodiment shown in FIG. 3. Details are not described herein again.

Step 602: Obtain control information, where the control information indicates at least one of content description metadata, rendering format flag information, loudspeaker configuration information, application scene information, tracking information, posture information, or location information.

For descriptions of step 602, refer to the specific descriptions of step 402 in the embodiment shown in FIG. 3. Details are not described herein again.

Step 603: Perform signal format conversion on the to-be-rendered audio signal based on the control information to obtain a sixth audio signal.

The signal format conversion includes at least one of converting a sound-channel-based audio signal in the to-be-rendered audio signal into a scene-based or object-based audio signal; converting a scene-based audio signal in the to-be-rendered audio signal into a sound-channel-based or object-based audio signal; or converting an object-based audio signal in the to-be-rendered audio signal into a sound-channel-based or scene-based audio signal.

An example in which the to-be-rendered audio signal is a PCM signal 2 is used. As shown in FIG. 9B, corresponding signal format conversion may be selected based on the control information, and the PCM signal 2 in one signal format is converted into a PCM signal 3 in another signal format.

In this embodiment of this application, signal format conversion may be adaptively selected based on the control information, so that a part of input signals (the to-be-rendered audio signal herein) can be converted by using one signal format conversion (for example, any one of the foregoing signal format conversions), and the other part of input signals can be converted by using another signal format conversion.

For example, in an application scene of binaural rendering, sometimes a part of input signals need to be rendered in a direct convolution manner, and the other part of input signals need to be rendered in an HOA manner. Therefore, a scene-based audio signal may be first converted into a sound-channel-based audio signal through signal format conversion, so that direct convolution processing is performed in a subsequent binaural rendering process, and an object-based audio signal is converted into a scene-based audio signal, so that rendering processing is subsequently performed in the HOA manner. For another example, the posture information and the location information in the control information indicate that a listener needs to perform 6DoF rendering processing. In this case, a sound-channel-based audio signal may be first converted into an object-based audio signal through signal format conversion, and a scene-based audio signal may be converted into an object-based audio signal.

When signal format conversion is performed on the to-be-rendered audio signal, processing performance of a terminal device may be further combined. The processing performance of the terminal device may be performance of a processor of the terminal device, for example, a dominant frequency or a bit quantity of the processor. An implementation of performing signal format conversion on the to-be-rendered audio signal based on the control information may include: performing signal format conversion on the to-be-rendered audio signal based on the control information, a signal format of the to-be-rendered audio signal, and the processing performance of the terminal device. For example, the posture information and the location information in the control information indicate that the listener needs to perform 6DoF rendering processing, and whether to perform conversion is determined with reference to the performance of the processor of the terminal device. For example, if processor performance of the terminal device is poor, an object-based audio signal or a sound-channel-based audio signal may be converted into a scene-based audio signal. If processor performance of the terminal device is good, a scene-based audio signal or a sound-channel-based audio signal may be converted into an object-based audio signal.

In an implementation, whether to perform conversion and a converted signal format are determined based on the posture information and the location information in the control information and the signal format of the to-be-rendered audio signal.

When a scene-based audio signal is converted into an object-based audio signal, the scene-based audio signal may be first converted into a virtual loudspeaker signal, and then each virtual loudspeaker signal and its corresponding location are an object-based audio signal, where the virtual loudspeaker signal is audio content, and the corresponding location is information in metadata .

Step 604: Perform binaural rendering or loudspeaker rendering on the sixth audio signal to obtain a rendered audio signal.

For descriptions of step 604, refer to specific descriptions of step 504 in FIG. 6A. Details are not described herein again. To be specific, the first audio signal in step 504 in FIG. 6A is replaced with the sixth audio signal.

In this embodiment, the to-be-rendered audio signal is obtained by decoding the received bitstream. Signal format conversion is performed on the to-be-rendered audio signal based on at least one of the content description metadata, the rendering format flag information, the loudspeaker configuration information, the application scene information, the tracking information, the posture information, or the location information indicated by the control information, to obtain the sixth audio signal. Binaural rendering or loudspeaker rendering is performed on the sixth audio signal to obtain the rendered audio signal. A rendering manner can be adaptively selected based on at least one piece of input information of the content description metadata, the rendering format flag information, the loudspeaker configuration information, the application scene information, the tracking information, the posture information, or the location information, thereby improving audio rendering effect. Signal format conversion is performed on the to-be-rendered audio signal based on the control information, so that flexible signal format conversion can be implemented. Therefore, the audio signal rendering method in embodiments of this application is applicable to any signal format, and audio rendering effect can be improved by rendering an audio signal in a proper signal format.

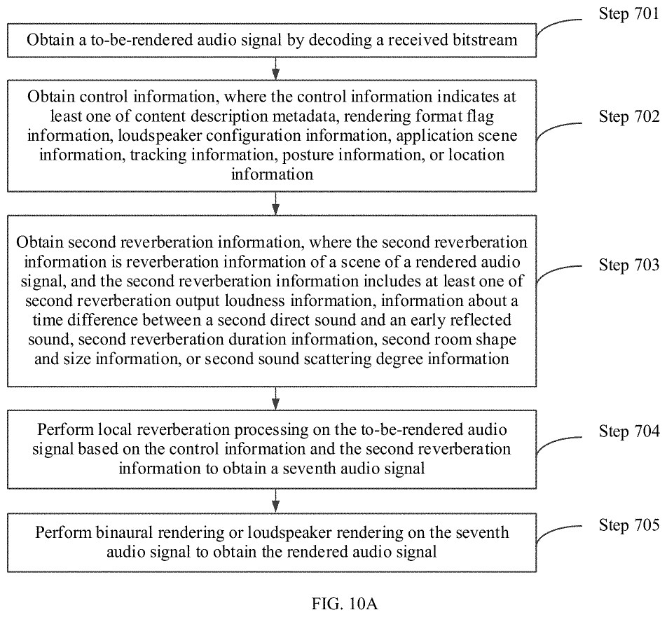

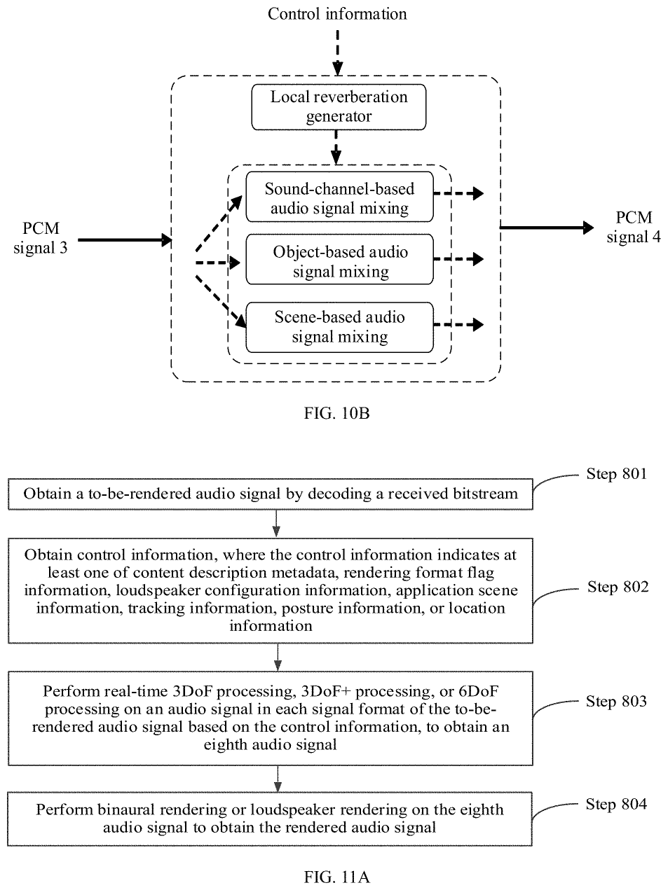

FIG. 10A is a flowchart of another audio signal rendering method according to an embodiment of this application. FIG. 10B is a schematic diagram of local reverberation processing according to an embodiment of this application. This embodiment of this application may be executed by the foregoing audio signal rendering apparatus. This embodiment is an implementation of the embodiment shown in FIG. 3, that is, specifically describes local reverberation processing of the audio signal rendering method in embodiments of this application. Local reverberation processing may implement rendering based on reverberation information of a replaying end, to improve rendering effect, so that the audio signal rendering method may support an application scene such as AR. As shown in FIG. 10A, the method in this embodiment may include the following steps.

Step 701: Obtain a to-be-rendered audio signal by decoding a received bitstream.

For descriptions of step 701, refer to specific descriptions of step 401 in the embodiment shown in FIG. 3. Details are not described herein again.

Step 702: Obtain control information, where the control information indicates at least one of content description metadata, rendering format flag information, loudspeaker configuration information, application scene information, tracking information, posture information, or location information.

For descriptions of step 702, refer to the specific descriptions of step 402 in the embodiment shown in FIG. 3. Details are not described herein again.

Step 703: Obtain second reverberation information, where the second reverberation information is reverberation information of a scene of a rendered audio signal, and the second reverberation information includes at least one of second reverberation output loudness information, information about a time difference between a second direct sound and an early reflected sound, second reverberation duration information, second room shape and size information, or second sound scattering degree information.

The second reverberation information is reverberation information generated on an audio signal rendering apparatus side. The second reverberation information may also be referred to as local reverberation information.

In some embodiments, the second reverberation information may be generated based on application scene information of the audio signal rendering apparatus. The application scene information may be obtained by using configuration information set by a listener, or may be obtained by using a sensor. The application scene information may include location information, environment information, or the like.

Step 704: Perform local reverberation processing on the to-be-rendered audio signal based on the control information and the second reverberation information to obtain a seventh audio signal.

In an implementation, clustering processing may be performed on signals in different signal formats in the to-be-rendered audio signal based on the control information, to obtain at least one of a sound-channel-based group signal, a scene-based group signal, or an object-based group signal. Local reverberation processing is separately performed, based on the second reverberation information, on at least one of the sound-channel-based group signal, the scene-based group signal, or the object-based group signal, to obtain the seventh audio signal.

In other words, the audio signal rendering apparatus may generate reverberation information for audio signals in three formats such that the audio signal rendering method in embodiments of this application may be applied to an augmented reality scene, to improve sense of immediacy. In the augmented reality scene, because environment information of a real-time location of the replaying end cannot be predicted, reverberation information cannot be determined at a production end. In this embodiment, the corresponding second reverberation information is generated based on the application scene information that is input in real time, and is used for rendering processing, so that rendering effect can be improved.

For example, as shown in FIG. 10B, after clustering processing is performed on signals of different format types in a PCM signal 3 shown in FIG. 10B, signals in three formats such as the sound-channel-based group signal, the object-based group signal, and the scene-based group signal are output. Subsequently, reverberation processing is performed on the group signals in the three formats, to output the seventh audio signal, that is, a PCM signal 4 shown in FIG. 10B.

Step 705: Perform binaural rendering or loudspeaker rendering on the seventh audio signal to obtain the rendered audio signal.

For descriptions of step 705, refer to specific descriptions of step 504 in FIG. 6A. Details are not described herein again. To be specific, the first audio signal in step 504 in FIG. 6A is replaced with the seventh audio signal.

In this embodiment, the to-be-rendered audio signal is obtained by decoding the received bitstream. Local reverberation processing is performed on the to-be-rendered audio signal based on the second reverberation information and at least one of the content description metadata, the rendering format flag information, the loudspeaker configuration information, the application scene information, the tracking information, the posture information, or the location information indicated by the control information, to obtain the seventh audio signal. Binaural rendering or loudspeaker rendering is performed on the seventh audio signal, to obtain the rendered audio signal. A rendering manner can be adaptively selected based on at least one piece of input information of the content description metadata, the rendering format flag information, the loudspeaker configuration information, the application scene information, the tracking information, the posture information, or the location information, thereby improving audio rendering effect. The corresponding second reverberation information is generated based on the application scene information that is input in real time, and is used for rendering processing, so that audio rendering effect can be improved, and real-time reverberation that matches the AR application scene can be provided for the scene.

FIG. 11A is a flowchart of another audio signal rendering method according to an embodiment of this application. FIG. 11B is a schematic diagram of grouped source transformation according to an embodiment of this application. This embodiment of this application may be executed by the foregoing audio signal rendering apparatus. This embodiment is an implementation of the embodiment shown in FIG. 3, that is, specifically describes grouped source transformation of the audio signal rendering method in embodiments of this application. Grouped source transformation may reduce rendering processing complexity. As shown in FIG. 11A, the method in this embodiment may include the following steps.

Step 801: Obtain a to-be-rendered audio signal by decoding a received bitstream.

For descriptions of step 801, refer to specific descriptions of step 401 in the embodiment shown in FIG. 3. Details are not described herein again.

Step 802: Obtain control information, where the control information indicates at least one of content description metadata, rendering format flag information, loudspeaker configuration information, application scene information, tracking information, posture information, or location information.

For descriptions of step 802, refer to specific descriptions of step 402 in the embodiment shown in FIG. 3. Details are not described herein again.

Step 803: Perform real-time 3DoF processing, 3DoF+ processing, or 6DoF processing on an audio signal in each signal format of the to-be-rendered audio signal based on the control information, to obtain an eighth audio signal.

In this embodiment, audio signals in three signal formats may be processed based on 3DoF, 3DoF+, and 6DoF information in the control information, that is, audio signals in all formats are processed in a unified manner such that processing complexity can be reduced while processing performance is ensured.

Performing real-time 3DoF processing, 3DoF+ processing, or 6DoF processing on a sound-channel-based audio signal is calculating a relative orientation relationship between a listener and the sound-channel-based audio signal in real time. Performing real-time 3DoF processing, 3DoF+ processing, or 6DoF processing on an object-based audio signal is calculating a relative direction and a relative distance relationship between a listener and an object sound source signal in real time. Performing real-time 3DoF processing, 3DoF+ processing, or 6DoF processing on a scene-based audio signal is calculating a location relationship between a listener and the scene signal center in real time.

In an implementation, performing real-time 3DoF processing, 3DoF+ processing, or 6DoF processing on the sound-channel-based audio signal is obtaining a processed HRTF/BRIR data index based on an initial HRTF/BRIR data index and 3DoF/3DoF+/6DoF data of the listener at a current time. The processed HRTF/BRIR data index is used to reflect an orientation relationship between the listener and a sound channel signal.

In an implementation, performing real-time 3DoF processing, 3DoF+ processing, or 6 DoF processing on the object-based audio signal is obtaining a processed HRTF/BRIR data index based on an initial HRTF/BRIR data index and 3DoF/3DoF+/6DoF data of the listener at a current time. The processed HRTF/BRIR data index is used to reflect a relative direction and a relative distance relationship between the listener and an object signal.

In an implementation, performing real-time 3DoF processing, 3DoF+ processing, or 6DoF processing on the scene-based audio signal is obtaining a processed HRTF/BRIR data index based on a virtual loudspeaker signal and 3DoF/3DoF+/6DoF data of the listener at a current time. The processed HRTF/BRIR data index is used to reflect a location relationship between the listener and the virtual loudspeaker signal.

For example, as shown in FIG. 11B, real-time 3DoF processing, 3DoF+ processing, or 6DoF processing is separately performed on signals of different format types in a PCM signal 4 shown in FIG. 11B, and a PCM signal 5, that is, the eighth audio signal, is output. The PCM signal 5 includes the PCM signal 4 and the processed HRTF/BRIR data index.

Step 804: Perform binaural rendering or loudspeaker rendering on the eighth audio signal to obtain a rendered audio signal.

For descriptions of step 804, refer to specific descriptions of step 504 in FIG. 6A. Details are not described herein again. To be specific, the first audio signal in step 504 in FIG. 6A is replaced with the eighth audio signal.

In this embodiment, the to-be-rendered audio signal is obtained by decoding the received bitstream. Real-time 3DoF processing, 3DoF+ processing, or 6DoF processing is performed on an audio signal in each signal format of the to-be-rendered audio signal based on at least one of the content description metadata, the rendering format flag information, the loudspeaker configuration information, the application scene information, the tracking information, the posture information, or the location information indicated by the control information, to obtain the eighth audio signal. Binaural rendering or loudspeaker rendering is performed on the eighth audio signal, to obtain the rendered audio signal. A rendering manner can be adaptively selected based on at least one piece of input information of the content description metadata, the rendering format flag information, the loudspeaker configuration information, the application scene information, the tracking information, the posture information, or the location information, thereby improving audio rendering effect. Audio signals in all formats are processed in a unified manner, so that processing complexity can be reduced while processing performance is ensured.

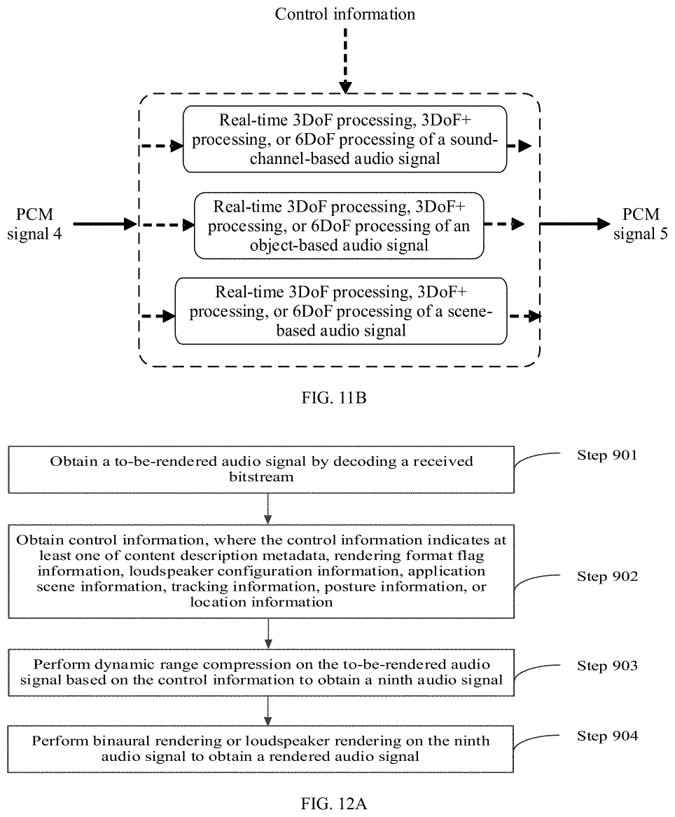

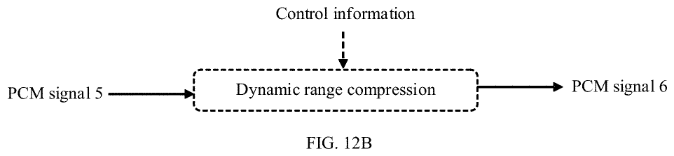

FIG. 12A is a flowchart of another audio signal rendering method according to an embodiment of this application. FIG. 12B is a schematic diagram of dynamic range compression according to an embodiment of this application. This embodiment of this application may be executed by the foregoing audio signal rendering apparatus. This embodiment is an implementation of the embodiment shown in FIG. 3, that is, specifically describes dynamic range compression of the audio signal rendering method in embodiments of this application. As shown in FIG. 12A, the method in this embodiment may include the following steps.

Step 901: Obtain a to-be-rendered audio signal by decoding a received bitstream.

For descriptions of step 901, refer to specific descriptions of step 401 in the embodiment shown in FIG. 3. Details are not described herein again.

Step 902: Obtain control information, where the control information indicates at least one of content description metadata, rendering format flag information, loudspeaker configuration information, application scene information, tracking information, posture information, or location information.

For descriptions of step 902, refer to specific descriptions of step 402 in the embodiment shown in FIG. 3. Details are not described herein again.

Step 903: Perform dynamic range compression on the to-be-rendered audio signal based on the control information to obtain a ninth audio signal.

Dynamic range compression may be performed on an input signal (for example, the to-be-rendered audio signal herein) based on the control information, to output the ninth audio signal.

In an implementation, dynamic range compression is performed on the to-be-rendered audio signal based on the application scene information and the rendering format flag information in the control information. For example, a home theater scene and a headphone rendering scene have different requirements for amplitudes of frequency responses. For another example, program content of different channels requires similar sound loudness, and same program content also requires a proper dynamic range. For still another example, for a stage play, it is necessary to ensure that conversation content can be clearly heard when a voice is light and that sound loudness is within a range when the music is loud. In this way, overall effect that the voice is suddenly high or low does not occur. For this example, dynamic range compression may be performed on the to-be-rendered audio signal based on the control information, to ensure audio rendering quality.

For example, refer to FIG. 12B. Dynamic range compression is performed on a PCM signal 5 shown in FIG. 12B, and a PCM signal 6, that is, the ninth audio signal, is output.

Step 904: Perform binaural rendering or loudspeaker rendering on the ninth audio signal to obtain a rendered audio signal.

For descriptions of step 904, refer to specific descriptions of step 504 in FIG. 6A. Details are not described herein again. To be specific, the first audio signal in step 504 in FIG. 6A is replaced with the ninth audio signal.

In this embodiment, the to-be-rendered audio signal is obtained by decoding the received bitstream. Dynamic range compression is performed on the to-be-rendered audio signal based on at least one of the content description metadata, the rendering format flag information, the loudspeaker configuration information, the application scene information, the tracking information, the posture information, or the location information indicated by the control information, to obtain the ninth audio signal. Binaural rendering or loudspeaker rendering is performed on the ninth audio signal to obtain the rendered audio signal. A rendering manner can be adaptively selected based on at least one piece of input information of the content description metadata, the rendering format flag information, the loudspeaker configuration information, the application scene information, the tracking information, the posture information, or the location information, thereby improving audio rendering effect.

FIG. 6A to FIG. 12B are used above to provide descriptions of performing rendering pre-processing on the to-be-rendered audio signal based on the control information, performing signal format conversion on the to-be-rendered audio signal based on the control information, performing local reverberation processing on the to-be-rendered audio signal based on the control information, performing grouped source transformation on the to-be-rendered audio signal based on the control information, performing dynamic range compression on the to-be-rendered audio signal based on the control information, performing binaural rendering on the to-be-rendered audio signal based on the control information, and performing loudspeaker rendering on the to-be-rendered audio signal based on the control information. That is, the control information may enable the audio signal rendering apparatus to adaptively select a rendering processing manner, thereby improving rendering effect of the audio signal.

In some embodiments, the foregoing embodiments may be further implemented in combination, that is, one or more of rendering pre-processing, signal format conversion, local reverberation processing, grouped source transformation, or dynamic range compression are selected based on the control information, to process the to-be-rendered audio signal such as to improve rendering effect of the audio signal.

In the following embodiment, an example in which rendering pre-processing , signal format conversion, local reverberation processing, grouped source transformation, and dynamic range compression are performed on the to-be-rendered audio signal based on the control information is used to describe the audio signal rendering method in embodiments of this application.

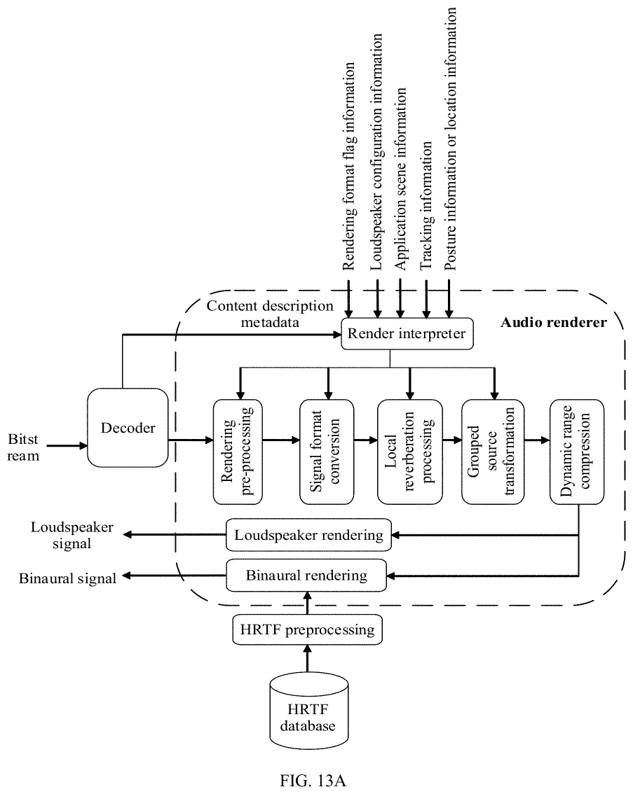

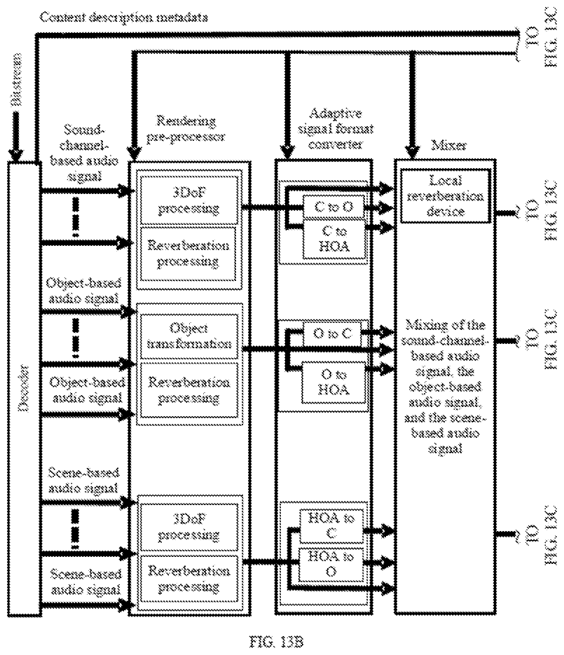

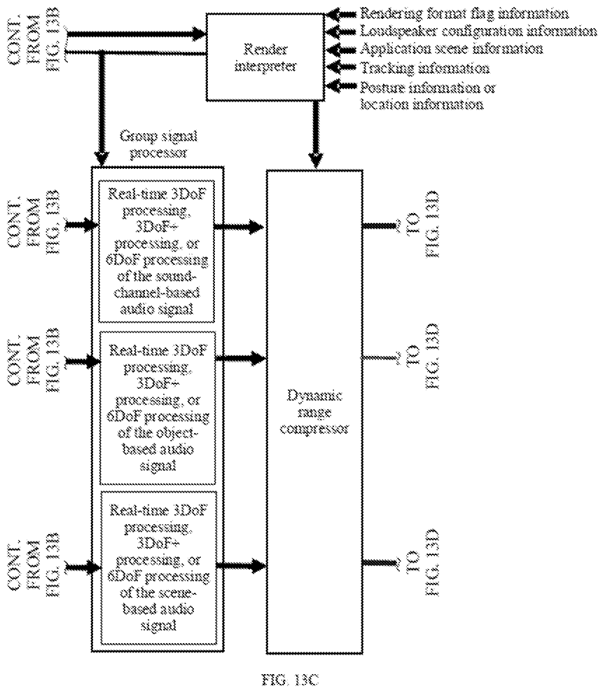

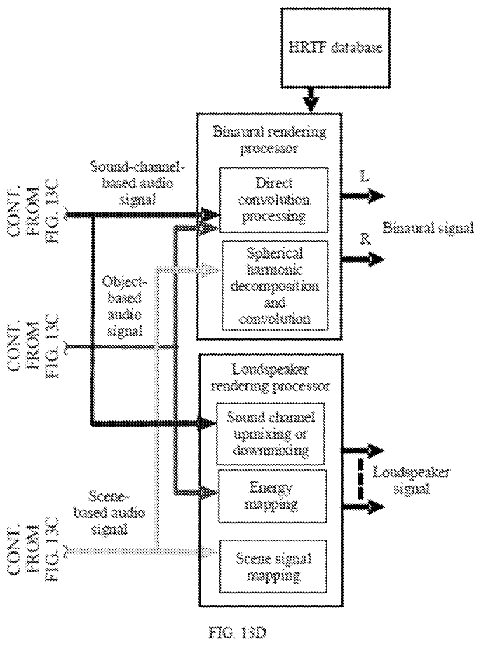

FIG. 13A is a schematic diagram of an architecture of an audio signal rendering apparatus according to an embodiment of this application. FIG. 13B to FIG. 13D are a schematic diagram of a detailed architecture of an audio signal rendering apparatus according to an embodiment of this application. As shown in FIG. 13A, the audio signal rendering apparatus in this embodiment of this application may include a render interpreter, a rendering preprocessor, an adaptive signal format converter, a mixer, a grouped source transformation processor, a dynamic range compressor, a loudspeaker rendering processor, and a binaural rendering processor. The audio signal rendering apparatus in this embodiment of this application has a flexible and universal rendering processing function. An output of a decoder is not limited to a single signal format, for example, a 5.1 multi-channel format or an HOA signal of a specific order, or may be a mixed form of three signal formats. For example, in an application scene of a multi-party remote conference call, some terminals send stereo sound channel signals, some terminals send object signals of a remote participant, and some terminals send high-order HOA signals. An audio signal received by the decoder by decoding a bitstream is a mixed signal of a plurality of signal formats. The audio rendering apparatus in this embodiment of this application can support flexible rendering of the mixed signal.

The render interpreter is configured to generate control information based on at least one of content description metadata, rendering format flag information, loudspeaker configuration information, application scene information, tracking information, posture information, or location information. The rendering preprocessor is configured to perform rendering pre-processing described in the foregoing embodiments on an input audio signal. The adaptive signal format converter is used to perform signal format conversion on the input audio signal. The mixer is used to perform local reverberation processing on the input audio signal. The grouped source transformation processor is configured to perform grouped source transformation on the input audio signal. The dynamic range compressor is configured to perform dynamic range compression on the input audio signal. The loudspeaker rendering processor is configured to perform loudspeaker rendering on the input audio signal. The binaural rendering processor is configured to perform binaural rendering on the input audio signal.

For a detailed framework diagram of the audio signal rendering apparatus, refer to FIG. FIG. 13B to FIG. 13D. The rendering preprocessor may separately perform rendering pre-processing on audio signals in different signal formats. For a specific implementation of the rendering pre-processing, refer to the embodiment shown in FIG. 6A. The audio signals in different signal formats output by the rendering preprocessor are input to the adaptive signal format converter. The adaptive signal format converter performs format conversion or does not perform format conversion on the audio signals in the different signal formats. For example, the adaptive signal format converter converts a sound-channel-based audio signal into an object-based audio signal (C to O shown in FIG. 13B to FIG. 13D), and converts the sound-channel-based audio signal into a scene-based audio signal (C to HOA shown in FIG. 13B to FIG. 13D); converts an object-based audio signal into a sound-channel-based audio signal (O to C as shown in FIG. 13B to FIG. 13D), and converts the object-based audio signal into a scene-based audio signal (O to HOA as shown in FIG. 13B to FIG. 13D); or converts a scene-based audio signal into a sound-channel-based audio signal (HOA to C shown in FIG. 13B to FIG. 13D), and converts the scene-based audio signal into an object-based audio signal (HOA to O shown in FIG. 13B to FIG. 13D). Audio signals output by the adaptive signal format converter are input to the mixer.

The mixer performs clustering on the audio signals in different signal formats to obtain group signals in different signal formats. A local reverberation device performs reverberation processing on the group signals in different signal formats, and inputs processed audio signals to the grouped source transformation processor. The grouped source transformation processor separately performs real-time 3DoF processing, 3DoF+ processing, or 6DoF processing on the group signals in different signal formats. Audio signals output by the grouped source transformation processor are input to the dynamic range compressor, and the dynamic range compressor performs dynamic range compression on the audio signals output by the grouped source transformation processor, and outputs the compressed audio signals to the loudspeaker rendering processor or the binaural rendering processor. The binaural rendering processor performs direct convolution processing on the sound-channel-based and object-based audio signals in the input audio signals, and performs spherical harmonic decomposition convolution on the scene-based audio signal in the input audio signals, to output a binaural signal. The loudspeaker rendering processor performs sound channel upmixing or downmixing on the sound-channel-based audio signal in the input audio signals, performs energy mapping on the object-based audio signal in the input audio signals, and performs scene signal mapping on the scene-based audio signal in the input audio signals, to output loudspeaker signals.

Based on the same idea as the foregoing method, an embodiment of this application further provides an audio signal rendering apparatus.

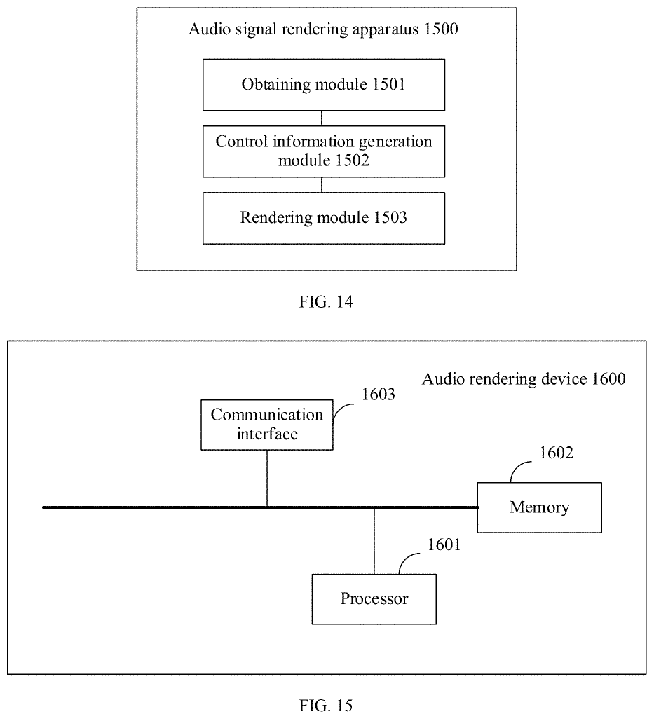

FIG. 14 is a schematic diagram of a structure of an audio signal rendering apparatus according to an embodiment of this application. As shown in FIG. 14, an audio signal rendering apparatus 1500 includes an obtaining module 1501, a control information generation module 1502, and a rendering module 1503.

The obtaining module 1501 is configured to obtain a to-be-rendered audio signal by decoding a received bitstream.

The control information generation module 1502 is configured to obtain control information, where the control information indicates at least one of content description metadata, rendering format flag information, loudspeaker configuration information, application scene information, tracking information, posture information, or location information.

The rendering module 1503 is configured to render the to-be-rendered audio signal based on the control information to obtain a rendered audio signal.

The content description metadata indicates a signal format of the to-be-rendered audio signal, where the signal format includes at least one of a sound-channel-based signal format, a scene-based signal format, or an object-based signal format. The rendering format flag information indicates an audio signal rendering format, and the audio signal rendering format includes loudspeaker rendering or binaural rendering. The loudspeaker configuration information indicates a layout of a loudspeaker. The application scene information indicates renderer scene description information. The tracking information indicates whether the rendered audio signal changes with head rotation of a listener. The posture information indicates an orientation and an amplitude of the head rotation. The location information indicates an orientation and an amplitude of body translation of the listener.

In some embodiments, the rendering module 1503 is configured to perform at least one of performing rendering pre-processing on the to-be-rendered audio signal based on the control information; performing signal format conversion on the to-be-rendered audio signal based on the control information; performing local reverberation processing on the to-be-rendered audio signal based on the control information; performing grouped source transformation on the to-be-rendered audio signal based on the control information; performing dynamic range compression on the to-be-rendered audio signal based on the control information; performing binaural rendering on the to-be-rendered audio signal based on the control information; or performing loudspeaker rendering on the to-be-rendered audio signal based on the control information.

In some embodiments, the to-be-rendered audio signal includes at least one of a sound-channel-based audio signal, an object-based audio signal, or a scene-based audio signal. The obtaining module 1501 is further configured to obtain first reverberation information by decoding the bitstream, where the first reverberation information includes at least one of first reverberation output loudness information, information about a time difference between a first direct sound and an early reflected sound, first reverberation duration information, first room shape and size information, or first sound scattering degree information. The rendering module 1503 is configured to perform control processing on the to-be-rendered audio signal based on the control information to obtain an audio signal obtained through the control processing, where the control processing may include at least one of performing initial 3DoF processing on the sound-channel-based audio signal, performing conversion processing on the object-based audio signal, or performing initial 3DoF processing on the scene-based audio signal; perform, based on the first reverberation information, reverberation processing on the audio signal obtained through the control processing, to obtain a first audio signal; and perform binaural rendering or loudspeaker rendering on the first audio signal to obtain the rendered audio signal.

In some embodiments, the rendering module 1503 is configured to perform signal format conversion on the first audio signal based on the control information, to obtain a second audio signal; and perform binaural rendering or loudspeaker rendering on the second audio signal to obtain the rendered audio signal.

The signal format conversion includes at least one of converting a sound-channel-based audio signal in the first audio signal into a scene-based or object-based audio signal; converting a scene-based audio signal in the first audio signal into a sound-channel-based or object-based audio signal; or converting an object-based audio signal in the first audio signal into a sound-channel-based or scene-based audio signal.

In some embodiments, the rendering module 1503 is configured to perform signal format conversion on the first audio signal based on the control information, a signal format of the first audio signal, and processing performance of a terminal device.

In some embodiments, the rendering module 1503 is configured to obtain second reverberation information, where the second reverberation information is reverberation information of a scene of the rendered audio signal, and the second reverberation information includes at least one of second reverberation output loudness information, information about a time difference between a second direct sound and an early reflected sound, second reverberation duration information, second room shape and size information, or second sound scattering degree information; perform local reverberation processing on the second audio signal based on the control information and the second reverberation information to obtain a third audio signal; and perform binaural rendering or loudspeaker rendering on the third audio signal to obtain the rendered audio signal.

In some embodiments, the rendering module 1503 is configured to separately perform clustering processing on audio signals in different signal formats in the second audio signal based on the control information, to obtain at least one of a sound-channel-based group signal, a scene-based group signal, or an object-based group signal; and separately perform, based on the second reverberation information, local reverberation processing on at least one of the sound-channel-based group signal, the scene-based group signal, or the object-based group signal, to obtain the third audio signal.

In some embodiments, the rendering module 1503 is configured to perform real-time 3DoF processing, 3DoF+ processing, or 6 degree of freedom 6DoF processing on a group signal in each signal format of the third audio signal based on the control information, to obtain a fourth audio signal; and perform binaural rendering or loudspeaker rendering on the fourth audio signal to obtain the rendered audio signal.

In some embodiments, the rendering module 1503 is configured to perform dynamic range compression on the fourth audio signal based on the control information, to obtain a fifth audio signal; and perform binaural rendering or loudspeaker rendering on the fifth audio signal to obtain the rendered audio signal.

In some embodiments, the rendering module 1503 is configured to perform signal format conversion on the to-be-rendered audio signal based on the control information, to obtain a sixth audio signal; and perform binaural rendering or loudspeaker rendering on the sixth audio signal to obtain the rendered audio signal.

The signal format conversion includes at least one of converting a sound-channel-based audio signal in the to-be-rendered audio signal into a scene-based or object-based audio signal; converting a scene-based audio signal in the to-be-rendered audio signal into a sound-channel-based or object-based audio signal; or converting an object-based audio signal in the to-be-rendered audio signal into a sound-channel-based or scene-based audio signal.

In some embodiments, the rendering module 1503 is configured to perform signal format conversion on the to-be-rendered audio signal based on the control information, the signal format of the to-be-rendered audio signal, and processing performance of a terminal device.

In some embodiments, the rendering module 1503 is configured to obtain second reverberation information, where the second reverberation information is reverberation information of a scene of the rendered audio signal, and the second reverberation information includes at least one of second reverberation output loudness information, information about a time difference between a second direct sound and an early reflected sound, second reverberation duration information, second room shape and size information, or second sound scattering degree information; perform local reverberation processing on the to-be-rendered audio signal based on the control information and the second reverberation information to obtain a seventh audio signal; and perform binaural rendering or loudspeaker rendering on the seventh audio signal to obtain the rendered audio signal.

In some embodiments, the rendering module 1503 is configured to perform real-time 3DoF processing, 3DoF+ processing, or 6 degree of freedom 6DoF processing on an audio signal in each signal format of the to-be-rendered audio signal based on the control information to obtain an eighth audio signal; and perform binaural rendering or loudspeaker rendering on the eighth audio signal to obtain the rendered audio signal.

In some embodiments, the rendering module 1503 is configured to perform dynamic range compression on the to-be-rendered audio signal based on the control information to obtain a ninth audio signal; and perform binaural rendering or loudspeaker rendering on the ninth audio signal to obtain the rendered audio signal.

It should be noted that the obtaining module 1501, the control information generation module 1502, and the rendering module 1503 may be applied to an audio signal rendering process on an encoder side.

It should be further noted that for specific implementation processes of the obtaining module 1501, the control information generation module 1502, and the rendering module 1503, refer to the detailed description of the foregoing method embodiment. For brevity of the specification, details are not described herein again.

Based on the same idea as the foregoing method, an embodiment of this application provides a device for rendering an audio signal, for example, an audio signal rendering device. As shown in FIG. 15, an audio signal rendering device 1600 includes a processor 1601, a memory 1602, and a communication interface 1603 (there may be one or more processors 1601 in the audio signal rendering device 1600, and in FIG. 15, one processor is used as an example). In some embodiments of this application, the processor 1601, the memory 1602, and the communication interface 1603 may be connected through a bus or in another manner. In FIG. 15, an example in which the processor 1601, the memory 1602, and the communication interface 1603 are connected through the bus is used.

The memory 1602 may include a ROM and a RAM, and provide instructions and data to the processor 1601. A part of the memory 1602 may further include a non-volatile RAM (NVRAM). The memory 1602 stores an operating system and operation instructions, an executable module or a data structure, or a subset thereof, or an extended set thereof. The operation instructions may include various operation instructions for performing various operations. The operating system may include various system programs for implementing various basic services and processing a hardware-based task.

The processor 1601 controls operations of an audio encoding device, and the processor 1601 may also be referred to as a CPU. In specific application, components of the audio encoding device are coupled together through a bus system. In addition to a data bus, the bus system may further include a power bus, a control bus, a status signal bus, and the like. However, for clear description, various types of buses in the figure are referred to as the bus system.

The methods disclosed in the foregoing embodiments of this application may be applied to the processor 1601, or may be implemented by the processor 1601. The processor 1601 may be an integrated circuit chip and has a signal processing capability. In an implementation process, the steps of the foregoing methods may be implemented by using an integrated logic circuit of hardware in the processor 1601, or by using instructions in a form of software. The processor 1601 may be a general-purpose processor, a DSP, an ASIC, an FPGA or another programmable logic device, a discrete gate or transistor logic device, or a discrete hardware component. The methods, the steps, and logical block diagrams that are disclosed in embodiments of this application may be implemented or performed. The general-purpose processor may be a microprocessor, or the processor may be any conventional processor or the like. The steps of the methods disclosed with reference to embodiments of this application may be directly executed and accomplished by using a hardware decoding processor, or may be executed and accomplished by using a combination of hardware and software modules in the decoding processor. The software module may be located in a mature storage medium in the art, for example, a RAM, a flash memory, a ROM, a programmable ROM, an EEPROM, or a register. The storage medium is located in the memory 1602. The processor 1601 reads information in the memory 1602, and completes the steps of the foregoing method in combination with hardware of the processor 1601.

The communication interface 1603 may be configured to receive or send digit or character information, for example, may be an input/output interface, a pin, or a circuit. For example, the foregoing encoded bitstream is received through the communication interface 1603.

Based on the same idea as the foregoing method, an embodiment of this application provides an audio rendering device, including a non-volatile memory and a processor that are coupled to each other. The processor invokes program code stored in the memory to perform a part or all of the steps of the audio signal rendering method in one or more of the foregoing embodiments.

Based on the same idea as the foregoing method, an embodiment of this application provides a computer-readable storage medium. The computer-readable storage medium stores program code, and the program code includes instructions for performing a part or all of the steps of the audio signal rendering method in one or more of the foregoing embodiments.

Based on the same idea as the foregoing method, an embodiment of this application provides a computer program product. When the computer program product runs on a computer, the computer is enabled to perform a part or all of the steps of the audio signal rendering method in one or more of the foregoing embodiments.

The processor in the foregoing embodiments may be an integrated circuit chip and has a signal processing capability. In an implementation process, steps in the foregoing method embodiments may be implemented by using an integrated logic circuit of hardware in the processor, or by using instructions in a form of software. The processor may be a general-purpose processor, a DSP, an ASIC, an FPGA or another programmable logic device, a discrete gate or transistor logic device, or a discrete hardware component. The general-purpose processor may be a microprocessor, or the processor may be any conventional processor or the like. The steps of the methods disclosed in embodiments of this application may be directly performed and completed by a hardware encoding processor, or performed and completed by a combination of hardware and a software module in an encoding processor. The software module may be located in a mature storage medium in the art, for example, a RAM, a flash memory, a ROM, a programmable ROM, an EEPROM, or a register. The storage medium is located in the memory. The processor reads information in the memory, and completes the steps in the foregoing methods in combination with hardware of the processor.

The memory in the foregoing embodiments may be a volatile memory or a non-volatile memory, or may include both a volatile memory and a non-volatile memory. The non-volatile memory may be a ROM, a programmable ROM PROM, an EPROM, an EEPROM, or a flash memory. The volatile memory may be a RAM, used as an external cache. Through example but not limitative description, many forms of RAMs may be used, for example, a static random access memory (SRAM), a DRAM, a synchronous DRAM (SDRAM), a double data rate SDRAM (DDR SDRAM), an enhanced SDRAM (ESDRAM), a SynchLink DRAM (SLDRAM), and a direct Rambus RAM (DR RAM). It should be noted that the memory of the systems and methods described in this specification includes but is not limited to these and any memory of another proper type.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions in this application essentially, or the part contributing to the conventional technology, or a part of the technical solutions may be implemented in a form of a computer software product. The computer software product is stored in a storage medium and includes several instructions for instructing a computer device (a personal computer, a server, a network device, or the like) to perform all or a part of the steps of the methods in embodiments of this application. The foregoing storage medium includes any medium that can store program code, such as a Universal-Serial Bus (USB) flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method comprising:
obtaining a to-be-rendered audio signal by decoding a bitstream; and
obtaining control information indicating at least one of:
content description metadata indicating a signal format of the to-be-rendered audio signal, wherein the signal format comprises at least one of a sound-channel-based signal format, a scene-based signal format, or an object-based signal format;
rendering format flag information indicating an audio signal rendering format, wherein the audio signal rendering format comprises loudspeaker rendering or binaural rendering;
loudspeaker configuration information indicating a layout of a loudspeaker;
application scene information indicating rendered scene description information;
tracking information indicating whether head rotation of a listener should change rendering;
posture information indicating an orientation and an amplitude of the head rotation; or
location information indicating an orientation and an amplitude of body translation of the listener; and
rendering the to-be-rendered audio signal based on the control information to obtain a rendered audio signal.

2. The method of claim 1, wherein rendering the to-be-rendered audio signal comprises at least one of:
performing rendering pre-processing on the to-be-rendered audio signal based on the control information;
performing signal format conversion on the to-be-rendered audio signal based on the control information;
performing local reverberation processing on the to-be-rendered audio signal based on the control information;
performing grouped source transformation on the to-be-rendered audio signal based on the control information;
performing dynamic range compression on the to-be-rendered audio signal based on the control information;
performing binaural rendering on the to-be-rendered audio signal based on the control information; or
performing loudspeaker rendering on the to-be-rendered audio signal based on the control information.

3. The method of claim 2, wherein the to-be-rendered audio signal comprises at least one of a sound-channel-based audio signal, an object-based audio signal, or a scene-based audio signal, and wherein performing rendering pre-processing on the to-be-rendered audio signal comprises:
obtaining first reverberation information by decoding the bitstream, wherein reverberation information comprises at least one of reverberation output loudness information, information about a time difference between a direct sound and an early reflected sound, reverberation duration information, room shape and size information, or sound scattering degree information;
performing control processing on the to-be-rendered audio signal based on the control information to obtain a first audio signal, wherein performing the control processing comprises at least one of performing initial 3 degree of freedom DoF processing on the sound-channel-based audio signal, performing conversion processing on the object-based audio signal, or performing initial 3DoF processing on the scene-based audio signal;
performing, based on the first reverberation information, reverberation processing on the first audio signal to obtain a second audio signal; and
performing second binaural rendering or second loudspeaker rendering on the second audio signal to obtain the rendered audio signal.

4. The method of claim 3, wherein the second audio signal comprises at least one of a second sound-channel-based audio signal, a second object-based audio signal, or a second scene-based audio signal, and wherein the performing second binaural rendering or the second loudspeaker rendering comprises:
performing second signal format conversion on the second audio signal based on the control information to obtain a third audio signal, wherein performing the second signal format conversion comprises at least one of converting the second sound-channel-based audio signal into the second scene-based audio signal or the second object-based audio signal, converting the second scene-based audio signal into the second sound-channel-based audio signal or the second object-based audio signal, or converting the second object-based audio signal into the second sound-channel-based audio signal or the second scene-based audio signal; and
performing third binaural rendering or third loudspeaker rendering on the third audio signal to obtain the rendered audio signal.

5. The method of claim 4, wherein performing the second signal format conversion comprises performing the second signal format conversion on the second audio signal based on the control information, a second signal format of the second audio signal, and processing performance of a terminal device.

6. The method of claim 4, wherein performing the third binaural rendering or the third loudspeaker rendering comprises:
obtaining second reverberation information of a scene of the rendered audio signal;
performing local reverberation processing on the third audio signal based on the control information and the second reverberation information to obtain a fourth audio signal; and
performing fourth binaural rendering or fourth loudspeaker rendering on the fourth audio signal to obtain the rendered audio signal.

7. The method of claim 6, wherein performing the local reverberation processing comprises:
separately performing clustering processing on audio signals in different signal formats in the third audio signal based on the control information to obtain at least one of a sound-channel-based group signal, a scene-based group signal, or an object-based group signal; and
performing, based on the second reverberation information, the local reverberation processing on at least one of the sound-channel-based group signal, the scene-based group signal, or the object-based group signal to obtain the third audio signal.

8. The method of claim 6, wherein performing the fourth binaural rendering or the fourth loudspeaker rendering on the third audio signal comprises:
performing 3DoF processing, 3DoF+ processing, or 6DoF processing on a group signal in each signal format of the third audio signal based on the control information to obtain a fifth audio signal; and
performing fifth binaural rendering or fifth loudspeaker rendering on the fifth audio signal to obtain the rendered audio signal.

9. The method of claim 8, wherein performing the fifth binaural rendering or the fifth loudspeaker rendering on the fifth audio signal comprises:
performing dynamic range compression on the fifth audio signal based on the control information to obtain a sixth audio signal; and
performing sixth binaural rendering or sixth loudspeaker rendering on the sixth audio signal to obtain the rendered audio signal.

10. The method of claim 1, wherein the rendering the to-be-rendered audio signal comprises:
performing signal format conversion on the to-be-rendered audio signal based on the control information to obtain an audio signal, wherein the to-be-rendered audio signal comprises a sound-channel-based audio signal, a scene-based audio signal, or an object-based audio signal, and wherein performing the signal format conversion comprises at least one of converting the sound-channel-based audio signal into the scene-based audio signal or the object-based audio signal, converting the scene-based audio signal into the sound-channel-based audio signal or the object-based audio signal, or converting the object-based audio signal into the sound-channel-based audio signal or scene-based audio signal; and
performing binaural rendering or loudspeaker rendering on the sixth audio signal to obtain the rendered audio signal.

11. The method of claim 10, wherein performing the signal format conversion on the to-be-rendered audio signal comprises performing signal format conversion on the to-be-rendered audio signal based on the control information, the signal format of the to-be-rendered audio signal, and processing performance of a terminal device.

12. The method of claim 1, wherein rendering the to-be-rendered audio signal comprises one of:
i) obtaining reverberation information of a scene of the rendered audio signal, wherein the reverberation information comprises at least one of reverberation output loudness information, information about a time difference between a second direct sound and an early reflected sound, reverberation duration information, room shape and size information, or sound scattering degree information;
performing local reverberation processing on the to-be-rendered audio signal based on the control information and the reverberation information to obtain a first audio signal; and
performing first binaural rendering or first loudspeaker rendering on the first audio signal to obtain the rendered audio signal; or
ii) performing real-time 3DoF processing, 3DoF+ processing, or 6DoF processing on a second audio signal in each signal format of the to-be-rendered audio signal based on the control information to obtain a third audio signal; and
performing second binaural rendering or second loudspeaker rendering on the third audio signal to obtain the rendered audio signal; or
iii) performing dynamic range compression on the to-be-rendered audio signal based on the control information to obtain a fourth audio signal; and
performing third binaural rendering or third loudspeaker rendering on the fourth audio signal to obtain the rendered audio signal.

13. An audio signal rendering apparatus, comprising:
a memory configured to store instructions; and
a processor coupled to the memory and configured to:
obtain a to-be-rendered audio signal by decoding a bitstream;
obtain control information indicating at least one of:
a signal format of the to-be-rendered audio signal, wherein the signal format comprises at least one of a sound-channel-based signal format, a scene-based signal format, or an object-based signal format;
rendering format flag information indicating an audio signal rendering format, wherein the audio signal rendering format comprises
loudspeaker rendering or binaural rendering; the loudspeaker configuration information indicating a layout of a loudspeaker;
application scene information indicating rendered scene description information;
tracking information indicating head rotation of a listener should change rendering;
posture information indicating an orientation and an amplitude of the head rotation; or
location information indicating an orientation and an amplitude of body translation of the listener; and
render the to-be-rendered audio signal based on the control information to obtain a rendered audio signal.

14. The audio signal rendering apparatus of claim 13, wherein the processor is further configured to
perform rendering pre-processing on the to-be-rendered audio signal based on the control information;
perform signal format conversion on the to-be-rendered audio signal based on the control information;
perform local reverberation processing on the to-be-rendered audio signal based on the control information;
perform grouped source transformation on the to-be-rendered audio signal based on the control information;
perform dynamic range compression on the to-be-rendered audio signal based on the control information;
perform binaural rendering on the to-be-rendered audio signal based on the control information; or perform loudspeaker rendering on the to-be-rendered audio signal based on the control information.

15. The audio signal rendering apparatus of claim 14, wherein the to-be-rendered audio signal comprises at least one of a sound-channel-based audio signal, an object-based audio signal, or a scene-based audio signal, and wherein the processor is further configured to:
obtain first reverberation information by decoding the bitstream, wherein reverberation information comprises at least one of reverberation output loudness information, information about a time difference between a direct sound and an early reflected sound, reverberation duration information, room shape and size information, or sound scattering degree information;
perform control processing on the to-be-rendered audio signal based on the control information to obtain a first audio signal, wherein to perform control processing, the processor is further configured to perform initial 3 degree of freedom (DoF) processing on the sound-channel-based audio signal, perform conversion processing on the object-based audio signal, or perform initial 3DoF processing on the scene-based audio signal;
perform, based on the first reverberation information, reverberation processing on the first audio signal to obtain a second audio signal; and
perform second binaural rendering or second loudspeaker rendering on the second audio signal to obtain the rendered audio signal.

16. The audio signal rendering apparatus of claim 15, wherein the second audio signal comprises at least one of a second sound-channel-based audio signal, a second object-based audio signal, or a second scene-based audio signal, and wherein the processor is further configured to:
perform second signal format conversion on the second audio signal based on the control information to obtain a third audio signal wherein to perform second signal format conversion, the processor is further configured to convert the second sound-channel-based audio signal into the second scene-based audio signal or the second object-based audio signal, convert the scene-based audio signal into the second sound-channel-based audio signal or the second object-based audio signal, or convert the second object-based audio signal into the second sound-channel-based audio signal or the second scene-based audio signal; and
perform third binaural rendering or third loudspeaker rendering on the third audio signal to obtain the rendered audio signal.

17. The audio signal rendering apparatus of claim 16, wherein the processor is further configured to perform the second signal format conversion on the second audio signal based on the control information, a second signal format of the second audio signal, and processing performance of a terminal device.

18. The audio signal rendering apparatus of claim 16, wherein the processor is further configured to:
obtain second reverberation information of a scene of the rendered audio signal;
perform local reverberation processing on the third audio signal based on the control information and the second reverberation information to obtain a fourth audio signal; and
perform fourth binaural rendering or fourth loudspeaker rendering on the fourth audio signal to obtain the rendered audio signal.

19. The audio signal rendering apparatus of claim 18, wherein the processor is further configured to:
separately perform clustering processing on audio signals in different signal formats in the third audio signal based on the control information to obtain at least one of a sound-channel-based group signal, a scene-based group signal, or an object-based group signal; and
perform, based on the second reverberation information, the local reverberation processing on at least one of the sound-channel-based group signal, the scene-based group signal, or the object-based group signal to obtain the third audio signal.

20. The audio signal rendering apparatus of claim 18, wherein the processor is further configured to:
perform 3DoF processing, 3DoF+ processing, or 6DoF processing on a group signal in each signal format of the fourth audio signal based on the control information to obtain a fifth audio signal; and
perform fifth binaural rendering or fifth loudspeaker rendering on the fifth audio signal to obtain the rendered audio signal.

21. The audio signal rendering apparatus of claim 20, wherein the processor is further configured to:
perform dynamic range compression on the fifth audio signal based on the control information to obtain a sixth audio signal; and
perform sixth binaural rendering or sixth loudspeaker rendering on the sixth audio signal to obtain the rendered audio signal.

22. The audio signal rendering apparatus of claim 13, wherein the processor is further configured to:
perform signal format conversion on the to-be-rendered audio signal based on the control information, to obtain an audio signal, wherein the to-be-rendered audio signal comprises a sound-channel-based audio signal, a scene-based audio signal, or an object-based audio signal, and wherein to perform signal format conversion, the processor is further configured to convert the sound-channel-based audio signal into the scene-based audio signal or the object-based audio signal, convert the scene-based audio signal into the sound-channel-based audio signal or the object-based audio signal, or convert the object-based audio signal in the to-be-rendered audio signal into a sound-channel-based or scene-based audio signal; and
perform binaural rendering or loudspeaker rendering on the audio signal to obtain the rendered audio signal.

23. The audio signal rendering apparatus of claim 22, wherein the processor is further configured to perform signal format conversion on the to-be-rendered audio signal based on the control information, the signal format of the to-be-rendered audio signal, and processing performance of a terminal device.

24. The audio signal rendering apparatus of claim 13, wherein the processor is further configured to:
i) obtain reverberation information of a scene of the rendered audio signal, wherein the reverberation information comprises at least one of reverberation output loudness information, information about a time difference between a second direct sound and an early reflected sound, reverberation duration information, room shape and size information, or sound scattering degree information;
perform local reverberation processing on the to-be-rendered audio signal based on the control information and the reverberation information to obtain a first audio signal; and
perform first binaural rendering or first loudspeaker rendering on the first audio signal to obtain the rendered audio signal; or
ii) perform real-time 3DoF processing, 3DoF+ processing, or 6DoF processing on a second audio signal in each signal format of the to-be-rendered audio signal based on the control information to obtain a third audio signal; and
perform second binaural rendering or second loudspeaker rendering on the third audio signal to obtain the rendered audio signal; or
iii) perform dynamic range compression on the to-be-rendered audio signal based on the control information to obtain a fourth audio signal; and
perform third binaural rendering or third loudspeaker rendering on the fourth audio signal to obtain the rendered audio signal.

25. A computer program product comprising computer-executable instructions that are stored on a non-transitory computer-readable storage medium and that, when executed by a processor, causes an audio signal rendering apparatus to:
obtain a to-be-rendered audio signal by decoding a bitstream;
obtain control information indicating at least one of:
content description metadata indicating a signal format of the to-be-rendered audio signal, wherein the signal format comprises at least one of a sound-channel-based signal format, a scene-based signal format, or an object-based signal format;
rendering format flag information indicating an audio signal rendering format, wherein the audio signal rendering format comprises loudspeaker rendering or binaural rendering;
loudspeaker configuration information indicating a layout of a loudspeaker;
application scene information indicating rendered scene description information;
tracking information indicating whether head rotation of a listener should change rendering;
posture information indicating an orientation and an amplitude of the head rotation; or
location information indicating an orientation and an amplitude of body translation of the listener; and
rendering the to-be-rendered audio signal based on the control information to obtain a rendered audio signal.
